(19) United States
(12) Patent Application Publication
(10) Pub. No.: US 2026/0070048 A1
(43) Pub. Date: Mar. 12, 2026

(54) NITROGEN-CONTAINING BRANCHED POLYMER, ANION EXCHANGE MEMBRANE, AND METHOD FOR PREPARING ANION EXCHANGE RESIN

(71) Applicant: Eve Hydrogen Energy Co., Ltd., Huizhou (CN)

(72) Inventors: Xia Liu, Huizhou (CN); XIANGDONG SU, HUIZHOU (CN); Ying Wang, Huizhou (CN)

(21) Appl. No.: 19/014,158

(22) Filed: Jan. 8, 2025

(30) Foreign Application Priority Data
Sep. 9, 2024 (CN) 202411262014.0

(51) Int. Cl. B01J 41/05; B01J 41/13; B01J 47/12; C08G 10/00; C08J 5/22

(52) U.S. Cl. CPC B01J 41/05; B01J 41/13; B01J 47/12; C08G 10/00; C08J 5/2256; C08J 2361/18

(57) ABSTRACT

A nitrogen-containing branched polymer, an anion exchange membrane, and a method for preparing an anion exchange resin are provided. A molecular structure of the nitrogen-containing branched polymer includes a nitrogen-containing heterocycle, a branched structure, and an aryl group. The number of branching site of the branched structure is not less than 3. The aryl group is connected to the branching site of the branched structure through the nitrogen-containing heterocycle. The aryl group and the branched structure satisfy a relationship: A:B=80-99:1-20. A polydispersity index of the nitrogen-containing branched polymer is not greater than 2.6. A weight-average molecular weight of the nitrogen-containing branched polymer is in a range of 40,000 g/mol-500,000 g/mol.

### CROSS-REFERENCE TO RELATED APPLICATION

This application claims the priority of Chinese Patent Application No. 202411262014.0, filed on Sep. 9, 2024, the disclosure of which is hereby incorporated by reference in their entireties.

### FIELD

The present disclosure relates to the technical field of anion exchange membranes, and particularly to a nitrogen-containing branched polymer, an anion exchange membrane, and a method for preparing an anion exchange resin.

### BACKGROUND

Trade-off effect generally refers to a situation in which a trade-off choice is made between two or more parameters. The Trade-off effect indicates that for the same product, when a priority is given to one performance, another performance may be compromised, and vice versa. In the field of materials, the trade-off effect poses an obstacle to popularization and application of new materials.

An anion exchange membrane is a core component of an alkaline electrochemical device. A function of the anion exchange membrane is to conduct OH— from a cathode to an anode of the electrochemical device and can simultaneously play a role in blocking a direct transfer of gas and electrons between the cathode and the anode. Key property requirements of the anion exchange membrane related to the alkaline electrochemical device are high ionic conductivity, low swelling rate, high mechanical strength, and excellent alkali-resistant stability.

When developing an ideal AEM for the alkaline electrochemical device, both a polymer backbone and a cationic group of the AEM are important considerations. Currently, a general strategy is to combine a polyaromatic hydrocarbon backbone without aryl ether as the polymer backbone with a nitrogen-containing heterocycle as the cationic group to improve durability of the AEM. However, the trade-off effect between ionic conductivity and structural stability is still a main problem faced by the AEM. High ionic conductivity of the AEM requires sufficient conductive groups. However, introduction of conductive groups may inevitably lead to a decrease in the structural stability and mechanical property of the membrane materials. A cross-linking method can be used to improve mechanical stability of the AME. However, the cross-linking may cause a significant decrease in ionic conducting ability of the AME and also reduce toughness of the membrane to a certain extent, making the membrane brittle. Additionally, there is also a trade-off effect between the ionic conductivity and water absorption and swelling properties. The high ionic conductivity achieved by the AEM is often accompanied by high water absorption and swelling rates. Generally speaking, the greater the water absorption and swelling rates of the AEM, the richer and wider corresponding hydrated channels may be, which may lead to intensified hydrogen transmembrane permeation in practical applications and a significant safety hazard.

In conclusion, in the process of improving and developing the AEM, the trade-off effect is widespread among different performance indicators, which severely limits the industrialization of the AEM of this type of material system.

### SUMMARY

In order to alleviate the trade-off effect among the ionic conductivity, structural stability, and water absorption and swelling properties of the AEM, so as to improve the ionic conductivity, enhance the structural stability, and reduce the water absorption and swelling rates of the AEM, the present disclosure provides a nitrogen-containing branched polymer, an anion exchange resin, an anion exchange membrane, and an electrochemical device.

In a first aspect, a nitrogen-containing branched polymer is provided in the present disclosure. A molecular structure of the nitrogen-containing branched polymer includes a nitrogen-containing heterocycle, a branched structure, and an aryl group. The number of branching site of the branched structure is not less than 3. The aryl group is connected to the branching site of the branched structure through the nitrogen-containing heterocycle. The aryl group and the branched structure satisfy a relationship: A:B=80-99:1-20. In detail, A represents a molar proportion of the aryl group in the nitrogen-containing branched polymer, and B represents a molar proportion of the branched structure in the nitrogen-containing branched polymer. A polydispersity index of the nitrogen-containing branched polymer is not greater than 2.6. A weight-average molecular weight of the nitrogen-containing branched polymer is in a range of 40,000 g/mol-500,000 g/mol. By keeping each of contents of the aryl group and the branched structure in the nitrogen-containing branched polymer within a specific ratio range, a basic skeleton of the nitrogen-containing branched polymer has a high structural strength and contains abundant conductive groups. Based on the above-mentioned skeleton, each of the weight-average molecular weight and the polydispersity index (PDI) of the nitrogen-containing branched polymer within a certain range enables the structural strength of the nitrogen-containing branched polymer to be further improved, and the water absorption and swelling rates to be at a low level. Based on this, the trade-off effect among the ionic conductivity, structural stability, and water absorption and swelling properties of the nitrogen-containing branched polymer can be alleviated. The nitrogen-containing branched polymer provided in the present disclosure possesses excellent ionic conductivity and mechanical property on the premise of low water absorption and swelling rates, and is suitable for preparing highly efficient and stable anion exchange resins and anion exchange membranes.

In some embodiments, A:B-85-95:5-15.

In some embodiments, the aryl group includes at least one selected from the group consisting of biphenyl, terphenyl, and quaterphenyl.

In some embodiments, the branched structure includes a benzene ring with the branching site.

In some embodiments, the branched structure includes at least one structural unit selected from the group consisting of 1,3,5-triphenylbenzene, triphenylmethane, 9,10-benzophenanthrene, tetraphenylmethane, triptycene, 9,9-diphenylfluorene, 9,9′-spirobi[9H-fluorene], 9,9′-bifluorene, 9,9′-bicarbazole, 4,4′-bis(9-carbazolyl)-1,1′-biphenyl, 2-(9,9″-spirobifluoren-2-yl)-9,9″-spirobifluorene, and triphenylamine.

In some embodiments, the nitrogen-containing heterocycle includes at least one of piperidine ring and quinuclidine ring.

In some embodiments, a molecular structure of the nitrogen-containing branched polymer includes a chain segment I and a chain segment II. A structural formula of the chain segment I is [symbol] A-Ar₁ [symbol] ₓ. In detail, A represents the nitrogen-containing heterocycle, Ar1 represents the aryl group, and x represents a degree of polymerization of the chain segment I. The chain segment II is composed of the nitrogen-containing heterocycle and the branched structure. In the chain segment II, the nitrogen-containing heterocycle is directly connected to the branching site of the branched structure.

In some embodiments, the nitrogen-containing branched polymer includes a basic structural unit formed by connecting the chain segment I with the chain segment II. In the basic structural unit, the aryl group in the chain segment I is connected to the nitrogen-containing heterocycle in the chain segment II.

In some embodiments, in the basic structural unit, the number of the chain segment I directly connected to each chain segment II is ≥3.

In some embodiments, the weight-average molecular weight of the nitrogen-containing branched polymer is 40000 g/mol-250000 g/mol.

In some embodiments, the weight-average molecular weight of the nitrogen-containing branched polymer is 40000 g/mol-130000 g/mol.

In some embodiments, the aryl group is terphenyl.

In some embodiments, the aryl group is p-terphenyl.

In some embodiments, the nitrogen-containing polymer includes at least one selected from the group consisting of a nitrogen-containing branched polymer A, a nitrogen-containing branched polymer B, a nitrogen-containing branched polymer C, a nitrogen-containing branched polymer D, and a nitrogen-containing branched polymer E. The nitrogen-containing branched polymer A is

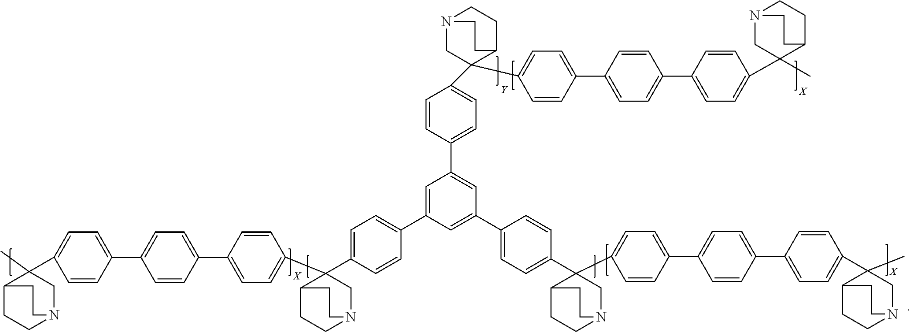

the nitrogen-containing branched polymer B is

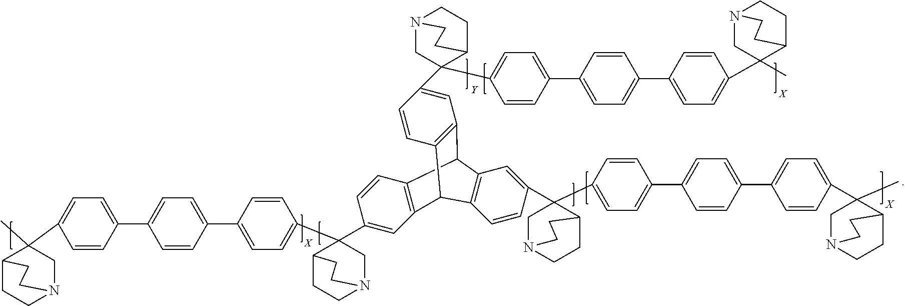

the nitrogen-containing branched polymer C is

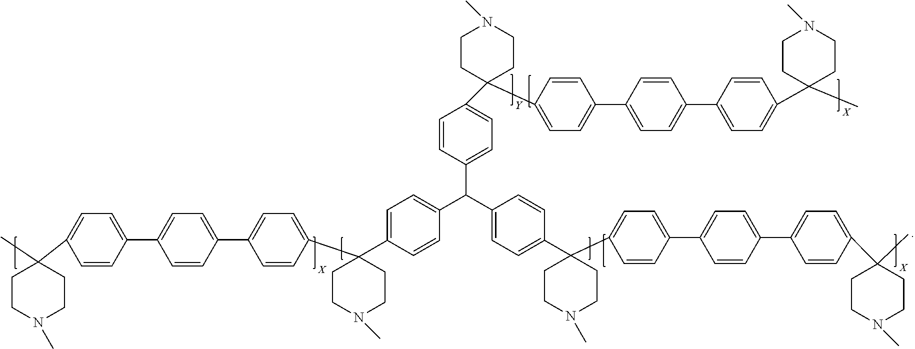

the nitrogen-containing branched polymer D is

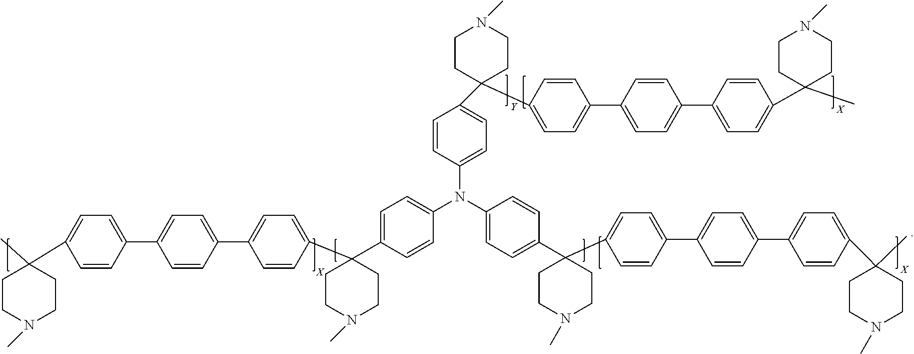

the nitrogen-containing branched polymer E is

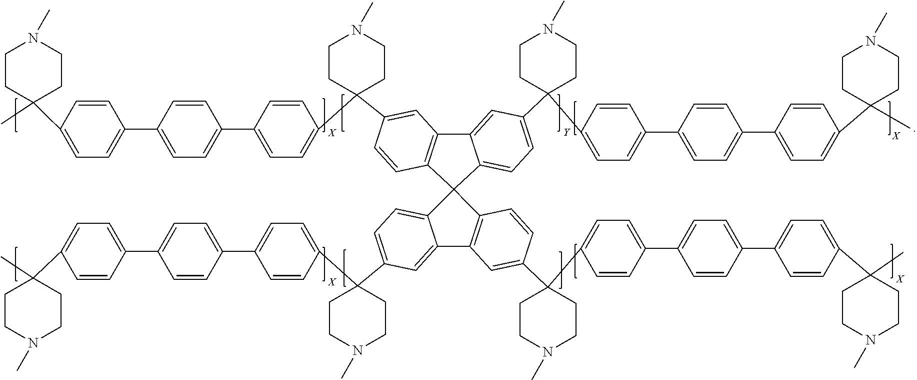

In a second aspect of the present disclosure, a method for preparing the nitrogen-containing branched polymer is provided and includes the following operations S1 to S4. In the operation S1, a reaction monomer mixture containing a monomer I, a monomer II, and a monomer III is prepared, and an acid catalyst is added to the reaction monomer mixture under a temperature of −5° C.-0° C. to obtain a reaction solution. Particularly, the monomer I is an aryl monomer, the monomer II is a monomer containing a branched structure, and the monomer III is a monomer containing a nitrogen-containing heterocycle. In the operation S2, the reaction solution is subjected to an oligomerization reaction to produce an oligomer mixture. Particularly, a reaction temperature of the oligomerization reaction is 0° C.-10° C. In the operation S3, the oligomer mixture is subjected to a high-polymerization reaction. Particularly, a reaction temperature of the high-polymerization reaction is 0° C.-24° C. In the operation S4, a polymer is separated from a product of the high-polymerization reaction, and an acid-removal treatment is performed on the polymer to obtain the nitrogen-containing branched polymer.

In some embodiments, in the operation S1, the acid catalyst is dropwise added to the reaction monomer mixture, and a dropping speed is 0.3 mL/min-2 mL/min.

In some embodiments, a reaction duration of the oligomerization reaction is 1 h-5 h, and a reaction duration of the high-polymerization reaction is 1 h-15 h.

In some embodiments, in the operation S4, the polymer is discharged through an extruder as a column-shaped extrudate. A diameter of a radial cross-section of the extrudate is 0.5 mm-2.5 mm.

In some embodiments, in the operation S4, the extrudate is discharged into pure water or an aqueous solution. A solute in the aqueous solution includes at least one selected from the group consisting of potassium carbonate, sodium carbonate, sodium chloride, potassium hydroxide, and calcium chloride.

In a third aspect, an anion exchange resin is provided in the present disclosure. The anion exchange resin includes a quaternization product of the nitrogen-containing branched polymer as described above. The above-mentioned anion exchange resin possesses both excellent ionic conductivity and mechanical property on the premise of having low water absorption and swelling rates, and can be used to prepare highly efficient and stable anion exchange membranes.

In some embodiments, the anion exchange resin includes at least one selected from the group consisting of anion exchange resin A, anion exchange resin B, anion exchange resin C, anion exchange resin D, anion exchange resin E, anion exchange resin F, anion exchange resin G, anion exchange resin H, anion exchange resin I, anion exchange resin J, anion exchange resin K, and anion exchange resin L. The anion exchange resin A is

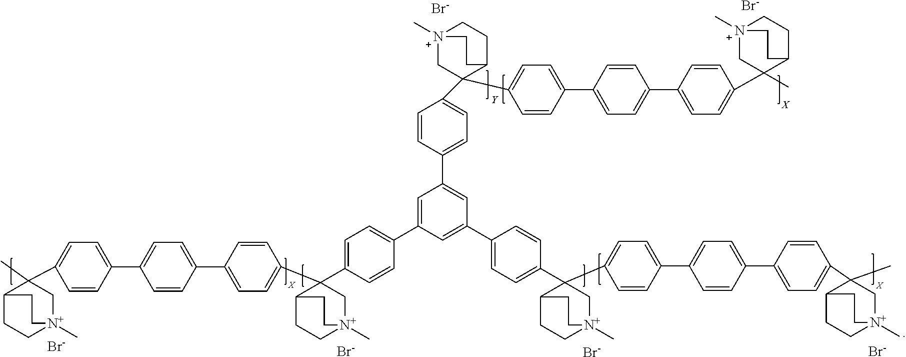

The anion exchange resin B is

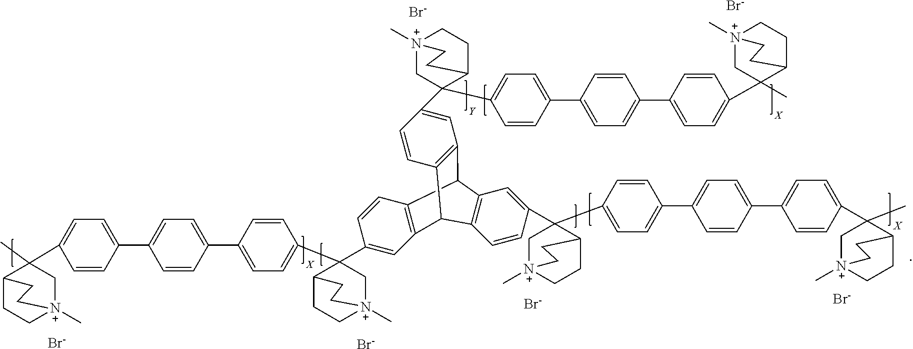

The anion exchange resin C is

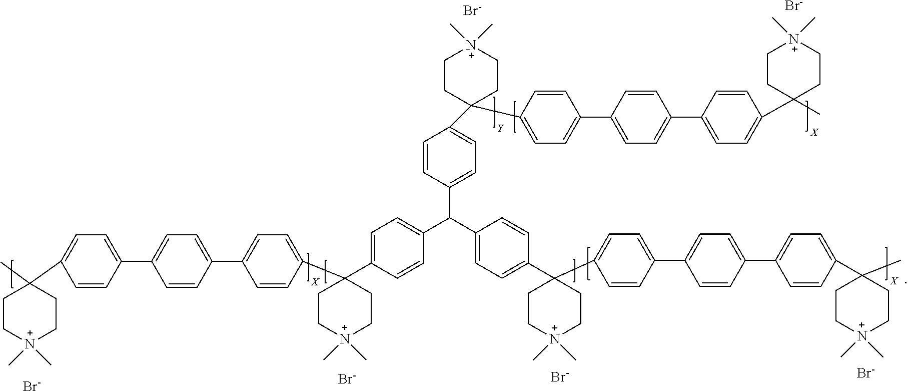

The anion exchange resin Dis

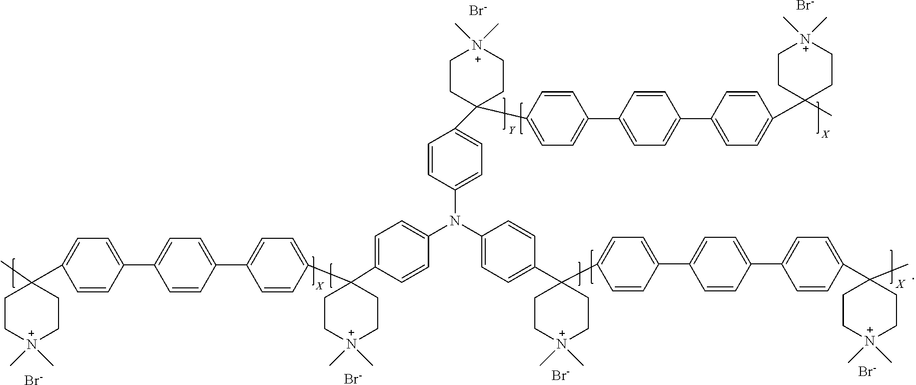

The anion exchange resin E is

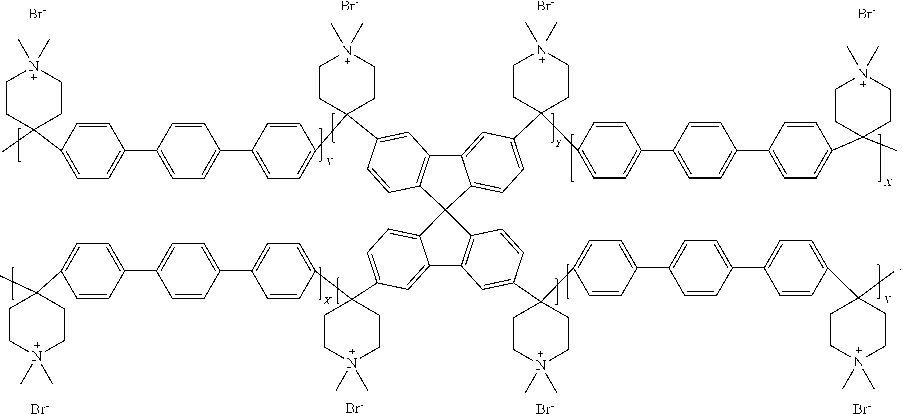

The anion exchange resin F is

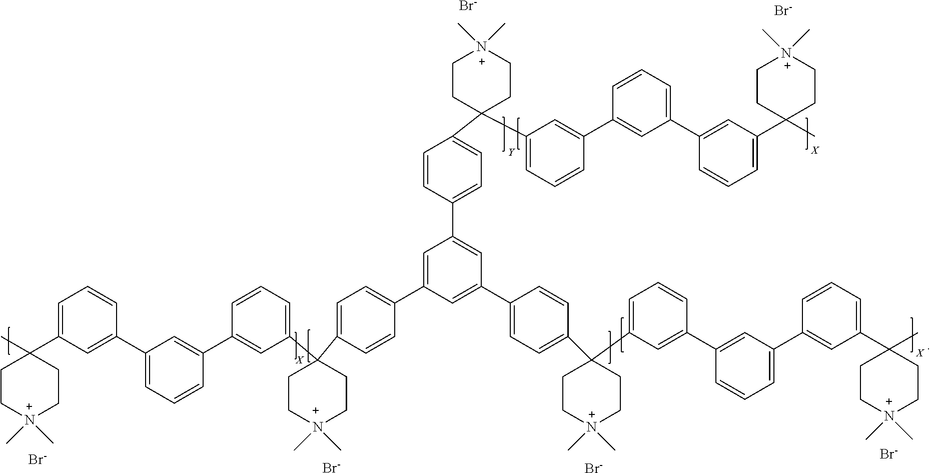

The anion exchange resin G is

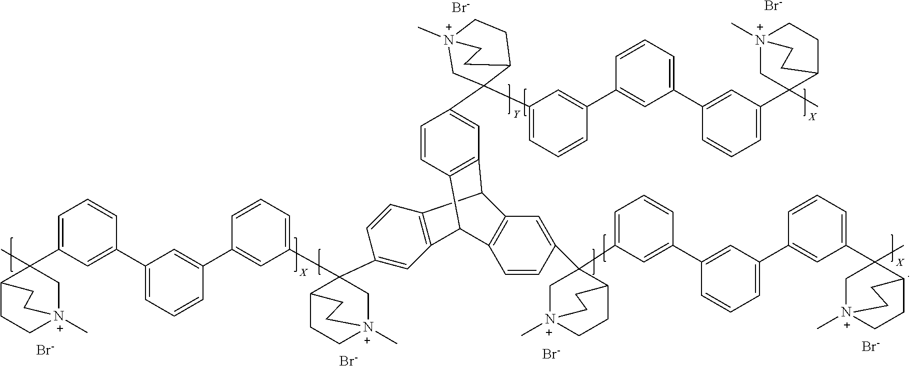

The anion exchange resin H is

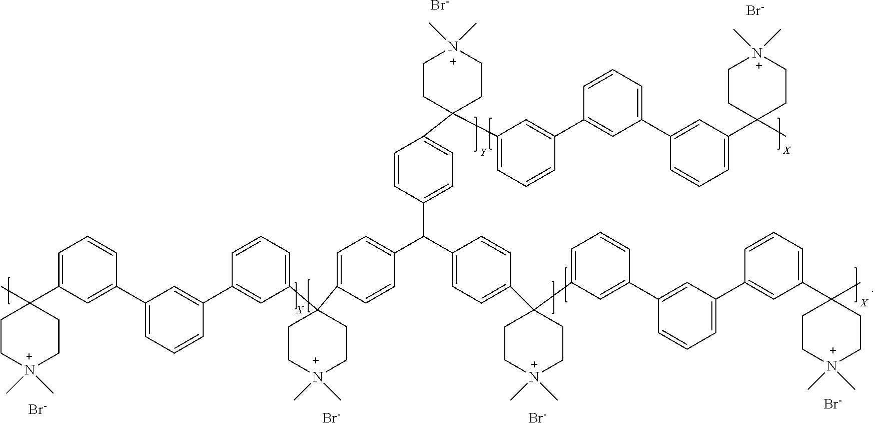

The anion exchange resin I is

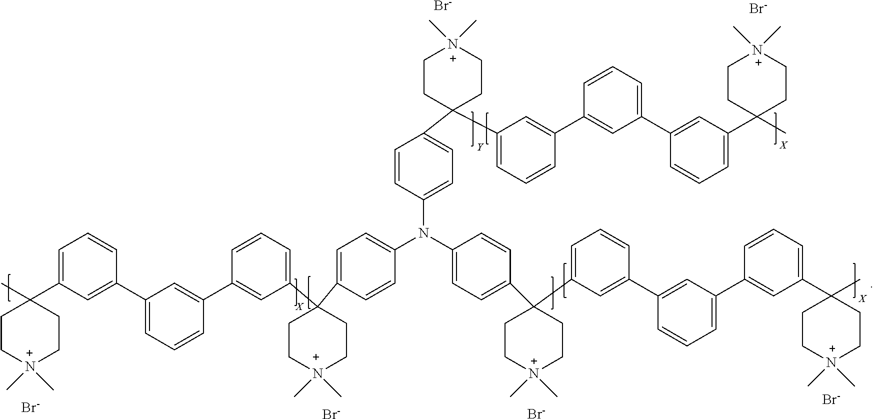

The anion exchange resin J is

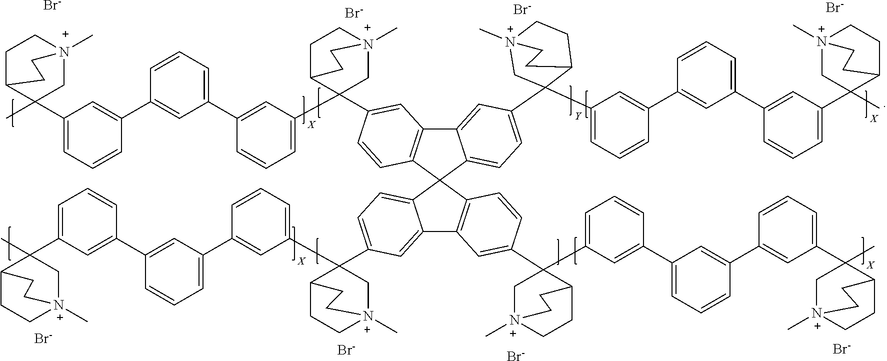

The anion exchange resin K is

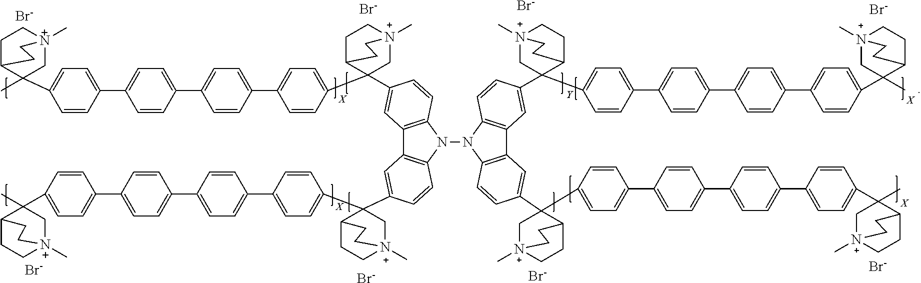

The anion exchange resin K is

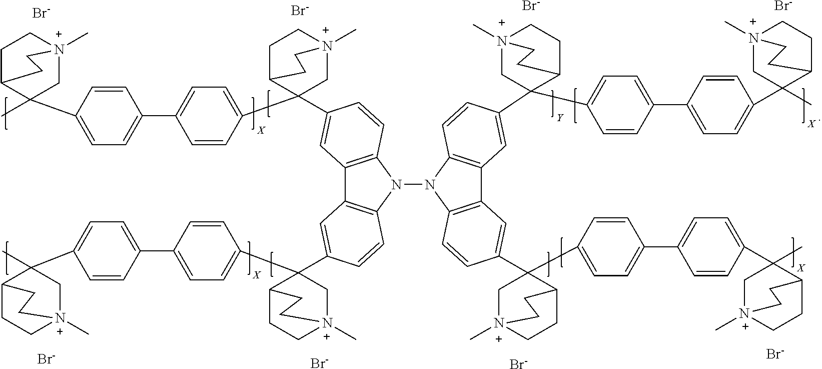

In some embodiments, the anion exchange resin includes at least one selected from the group consisting of the anion exchange resin A, the anion exchange resin B, the anion exchange resin C, the anion exchange resin D, and the anion exchange resin E.

In a fourth aspect of the present disclosure, a method for preparing the anion exchange resin is provided and includes the following operations S1 to S5. In the operation S1, a reaction monomer mixture containing a monomer I, a monomer II, and a monomer III is prepared, and an acid catalyst is added to the reaction monomer mixture under a temperature of −5° C.-0° C. to obtain a reaction solution. Particularly, the monomer I is an aryl monomer, the monomer II is a monomer containing the branched structure, and the monomer III is a monomer containing the nitrogen-containing heterocycle. In the operation S2, the reaction solution is subjected to an oligomerization reaction to produce an oligomer mixture. Particularly, a reaction temperature of the oligomerization reaction is 0° C.-10° C. In the operation S3, the oligomer mixture is subjected to a high-polymerization reaction. Particularly, a reaction temperature of the high-polymerization reaction is 0° C.-24° C. In the operation S4, a polymer is separated from a product of the high-polymerization reaction, and an acid-removal treatment is performed on the polymer to obtain the nitrogen-containing branched polymer. In the operation S5, a quaternization reaction solution is prepared by adding the nitrogen-containing branched polymer and a quaternization reagent to a solvent B for a quaternization reaction, and the anion exchange resin is separated from a product of the quaternization reaction.

By preparing the anion exchange resin through the above-mentioned method, a problem of non-uniform molecular weight faced when further increasing a degree of branching of a branched material can be effectively alleviated, and the anion exchange resin of the present disclosure can be controllably and stably prepared. Moreover, solubility of highly-branched material can be effectively improved, which ensures excellent performance of the anion exchange resin containing the branched structure.

In some embodiments, in the operation S1, the acid catalyst is dropwise added to the reaction monomer mixture. A dropping speed is 0.3 mL/min-2 mL/min.

In some embodiments, a reaction duration of the oligomerization reaction is 1 h-5 h, and a reaction duration of the high-polymerization reaction is 1 h-15 h.

In some embodiments, the monomer I includes at least one aryl monomer selected from the group consisting of:

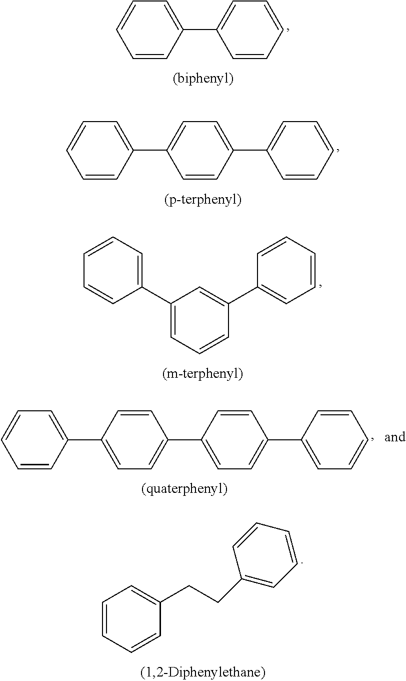

In some embodiments, the monomer II includes at least one selected from the group consisting of:

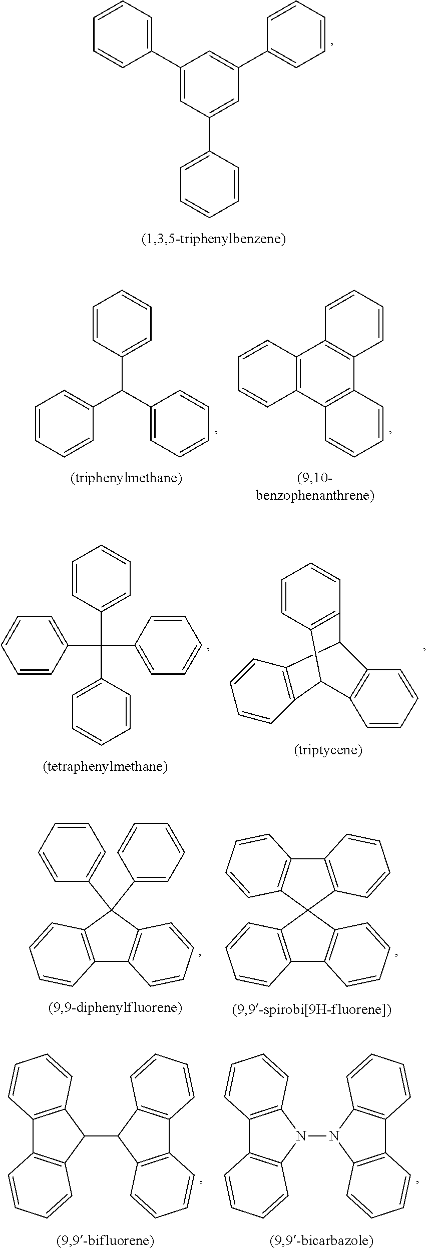

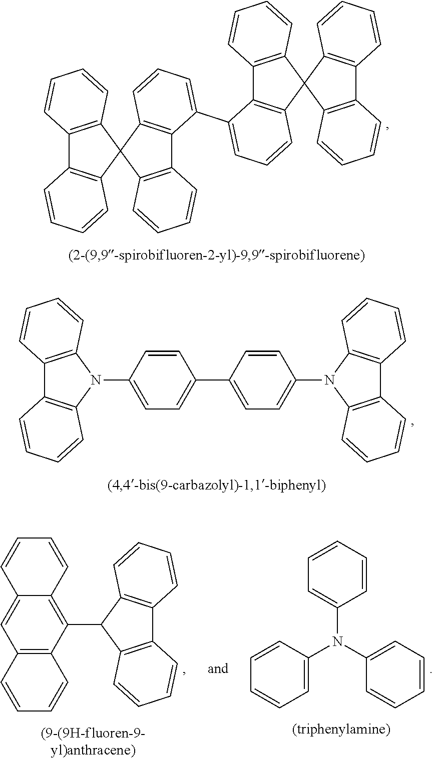

In some embodiments, the monomer III includes at least one of a piperidone monomer and a quinuclidone monomer.

In some embodiments, a structural formula of the piperidone monomer is

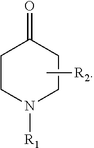

In detail, R1 and R2 are independently selected from the group consisting of methyl, ethyl, propyl, butyl, pentyl, and cyclopropyl.

In some embodiments, a structural formula of the quinuclidone monomer is

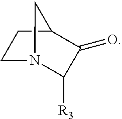

In detail, R3 hydrogen, alkyl, alkenyl, alkynyl or aromatic ring.

In some embodiments, the piperidone monomer includes at least one selected from the group consisting of:

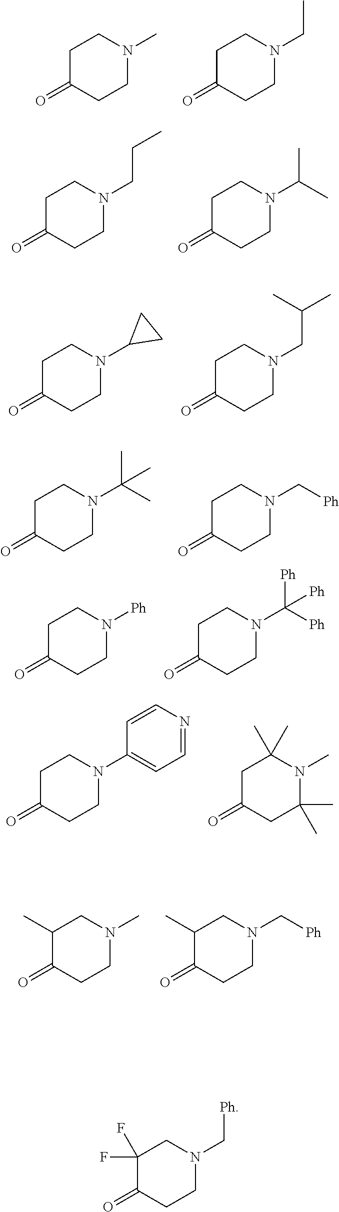

The quinuclidone monomer includes at least one selected from the group consisting of:

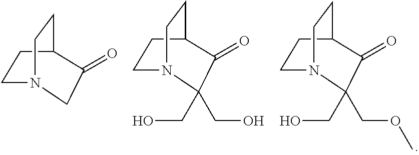

In some embodiments, the acid catalyst includes at least one selected from the group consisting of methanesulfonic acid, pentafluoropropionic acid, trifluoroacetic acid, trifluoromethanesulfonic acid, and heptafluorobutyric acid. Taking a feeding amount of the monomer III as an equivalent reference, a feeding amount of the acid catalyst is 4-14 eq.

In some embodiments, the acid catalyst includes trifluoroacetic acid and trifluoromethanesulfonic acid.

In some embodiments, taking a feeding amount of the monomer III as an equivalent reference, a ratio of a feeding amount of trifluoroacetic acid to a feeding amount of trifluoromethanesulfonic acid is 0.5 eq-3 eq: 3.5 eq-11 eq.

In some embodiments, in the operation S5, a molar ratio of a feeding amount of the nitrogen-containing branched polymer to a feeding amount of the quaternization reagent satisfies 1:(1-3).

In some embodiments, the quaternization reagent includes at least one selected from the group consisting of methyl trifluoroacetate, methyl p-toluenesulfonate, methyl iodide, propyl bromide, ethyl iodide, propyl iodide, butyl iodide, pentyl iodide, hexyl iodide, ethyl bromide, butyl bromide, pentyl bromide, hexyl bromide, bromocyclohexane, bromocyclopentane, bromocyclohexane, methyl methanesulfonate, ethyl methanesulfonate, propyl methanesulfonate, butyl methanesulfonate, propyl ethanesulfonate, ethyl ethanesulfonate, 3-butynyl methanesulfonate, Ethenesulfonic acid, 2-propenyl ester, methyl benzenesulfonate, methyl nitrobenzenesulfonate, methyl trifluoromethanesulfonate, ethyl trifluoromethanesulfonate, ethyl toluenesulfonate, toluene-4-sulfonic acid cyclobutyl ester, butyl toluene-4-sulphonate, benzenesulfonic acid neopentyl ester, tetrahydro-2H-pyran-4-yl methanesulfonate, and cyclohexyl p-toluenesulfonate.

In some embodiments, when the reaction monomer mixture is prepared, the monomer I, the monomer II, and the monomer III are added to a solvent A. The solvent A is composed of at least one selected from the group consisting of dichloromethane, trichloromethane, chloroform, and tetrahydrofuran.

In some embodiments, a reaction temperature of the quaternization reaction is 10° C.-100° C.

In some embodiments, a reaction duration of the quaternization reaction is 4 h-36 h.

In some embodiments, the solvent B is composed of at least one selected from the group consisting of dimethyl sulfoxide, tetrahydrofuran, N-methyl-2-pyrrolidone, N,N-dimethylformamide, N,N-dimethylacetamide, and acetonitrile.

In some embodiments, in the operation S5, when the anion exchange resin is separated from the product of the quaternization reaction, the following operations are specifically performed. A precipitating agent is added to the product of the quaternization reaction to produce a precipitate. After being washed and dried, the precipitate is subjected to an ion-exchange treatment to obtain the anion exchange resin. Particularly, the precipitating agent includes at least one selected from the group consisting of ethanol, ethyl acetate, ethylene glycol, diethyl ether, tetrahydrofuran, acetone, and water.

In a fifth aspect of the present disclosure, an anion exchange membrane is provided. The anion exchange membrane includes the above-mentioned anion exchange resin. The anion exchange membrane provided in the present disclosure not only has good mechanical property but also possesses a relatively high ionic conductivity. When the anion exchange membrane is applied to an electrochemical device, electrochemical performance and structural stability of the electrochemical device can be significantly improved. In addition, since the anion exchange membrane has low water absorption and swelling rates, hydrated channel volume of the anion exchange membrane can be reduced, thereby enabling the electrochemical device applying the anion exchange membrane to maintain a low hydrogen transmembrane permeability.

In a sixth aspect of the present disclosure, a method for preparing the anion exchange membrane is provided and include the following operations S1 to S6. In the operation S1, a reaction monomer mixture containing a monomer I, a monomer II, and a monomer III is prepared, and an acid catalyst is added to the reaction monomer mixture under a temperature of −5° C.-0° C. to obtain a reaction solution. Particularly, the monomer I is an aryl monomer, the monomer II is a monomer containing the branched structure, and the monomer III is a monomer containing the nitrogen-containing heterocycle. In the operation S2, the reaction solution is subjected to an oligomerization reaction to produce an oligomer mixture. Particularly, a reaction temperature of the oligomerization reaction is 0° C.-10° C. In the operation S3, the oligomer mixture is subjected to a high-polymerization reaction. Particularly, a reaction temperature of the high-polymerization reaction is 0° C.-24° C. In the operation S4, a polymer is separated from a product of the high-polymerization reaction, and an acid-removal treatment is performed on the polymer to obtain the nitrogen-containing branched polymer. In the operation S5, a quaternization reaction solution is prepared by adding the nitrogen-containing branched polymer and a quaternization reagent to a solvent B for a quaternization reaction, and the anion exchange resin is separated from a product of the quaternization reaction. In the operation S6, a homogeneous solution with a solute containing the anion exchange resin is prepared, the homogeneous solution is coated on a thin-film substrate, and the homogeneous solution on the thin-film substrate is dried to produce the anion exchange membrane.

In some embodiments, in the operation S1, the acid catalyst is dropwise added to the reaction monomer mixture, and a dropping speed is 0.3 mL/min-2 mL/min.

In some embodiments, a reaction duration of the oligomerization reaction is 1 h-5 h, and a reaction duration of the high-polymerization reaction is 1 h-15 h.

In some embodiments, a reaction temperature of the quaternization reaction is 10° C.-100° C.

In some embodiments, a reaction duration of the quaternization reaction is 4 h-36 h.

In some embodiments, the operation S6 specifically includes the following operations. The anion exchange resin is dissolved in a solvent C to obtain a mixture. The mixture is filtered through a diaphragm to obtain a filtrate. Particularly, a mesh number of the diaphragm is 2000-6000 meshes. The obtained filtrate is a homogeneous solution. The thin-film substrate is coated with the homogeneous solution to obtain a semi-finished product. The semi-finished product is dried at 60° C. for 8-12 h to produce the anion exchange membrane.

In some embodiments, the solvent C is composed of at least one selected from the group consisting of dimethyl sulfoxide, tetrahydrofuran, N-methyl-2-pyrrolidone, N,N-dimethylformamide, N,N-dimethylacetamide, and acetonitrile.

In a seventh aspect of the present disclosure, an electrochemical device is provided. The electrochemical device includes the above-mentioned anion exchange membrane. Based on the anion exchange membrane, hydrogen in oxygen in the above-mentioned electrochemical device can be kept in a safe control range for a long time, thereby enabling the electrochemical device to have a high safety. In addition, the relatively high ionic conductivity of the anion exchange membrane ensures that ions can be efficiently transferred inside the electrochemical device, thereby enabling the electrochemical device to have excellent electrochemical performances.

### BRIEF DESCRIPTION OF THE DRAWINGS

FIG. 1 is a structural view of an ionic conductivity testing device according to some embodiments in the present disclosure.

FIG. 2 is a statistical graph of tensile strength and elongation at break measured for test objects in Test Example 1.

FIG. 3 is a statistical graph of ionic conductivity, water absorption rate, and swelling rate measured for the test objects in Test Example 1.

FIG. 4 is a statistical graph of content of hydrogen in oxygen and polarization performance of alkaline membrane single cells applying the test objects in Test Example 1.

FIG. 5 is a statistical graph of tensile strength and elongation at break measured for test objects in Test Example 2.

FIG. 6 is a statistical graph of ionic conductivity, water absorption rate, and swelling rate measured for the test objects in Test Example 2.

FIG. 7 is a statistical graph of content of hydrogen in oxygen and polarization performance of alkaline membrane single cells applying the test objects in Test Example 2.

FIG. 8 is a statistical graph of tensile strength and elongation at break measured for test objects in Test Example 3.

FIG. 9 is a statistical graph of ionic conductivity, water absorption rate, and swelling rate measured for the test objects in Test Example 3.

FIG. 10 is a statistical graph of content of hydrogen in oxygen and polarization performance of alkaline membrane single cells applying the test objects in Test Example 3.

FIG. 11 is a statistical graph of tensile strength and elongation at break measured for test objects in Test Example 4.

FIG. 12 is a statistical graph of ionic conductivity, water absorption rate, and swelling rate measured for the test objects in Test Example 4.

FIG. 13 is a statistical graph of content of hydrogen in oxygen and polarization performance of alkaline membrane single cells using the test objects in Test Example 4.

### DETAILED DESCRIPTION

In order to enable those skilled in the art to better understand the technical solutions in the present disclosure, the following will clearly and completely describe the technical solutions of the present disclosure in combination with the embodiments of the present disclosure. Obviously, the described embodiments are only a part of the embodiments of the present disclosure, not all of them.

### Example 1-10

A method for preparing an anion exchange membrane included the following operations S1 to S6.

In the operation S1, 0.27 mol of monomer I, 0.03 mol of monomer II, and 0.36 mol of monomer III were added to 100 mL of dichloromethane and mixed thoroughly to obtain a reaction monomer mixture. Subsequently, an acid catalyst was added dropwise to the reaction monomer solution at a dropping rate of 1 mL/min at 0° C. to obtain a reaction solution. Particularly, the acid catalyst specifically included 22.8 mL of trifluoroacetic acid and 240 mL of trifluoromethanesulfonic acid. The monomer I was an aryl monomer, the monomer II was a monomer containing a branched structure, and the monomer III was a monomer containing a nitrogen-containing heterocycle.

In the operation S2, the reaction solution was kept at a reaction temperature of an oligomerization reaction for 1-1.5 h. During this process, monomers in the reaction solution were subjected to the oligomerization reaction under an action of the acid catalyst. After the oligomerization reaction is completed, an oligomer mixture was obtained.

In the operation S3, the oligomer mixture was heated to a reaction temperature of a high-polymerization reaction and kept at the reaction temperature of the high-polymerization reaction for 2-5.5 h. During this process, the oligomer mixture was subjected to a high-polymerization reaction.

In the operation S4, after the high-polymerization reaction was completed, the polymer produced from the operation S3 was discharged through an extruder into pure water, then filtered, washed with pure water, and dried, and then dissolved in an alkaline solution for an acid-removal treatment. After a sufficient acid-removal, an obtained precipitate was washed and dried to produce a nitrogen-containing branched polymer.

In the operation S5, 0.1 mol of the nitrogen-containing branched polymer produced from the operation S4 and 0.15 mol of methyl p-toluenesulfonate were added to 200 mL of dimethyl sulfoxide and mixed thoroughly to obtain a quaternization reaction solution. The quaternization reaction solution was heated to 80° C. and kept at 80° C. for 15 h to produce a quaternization solution. 2 L of ethyl acetate was added to the quaternization solution and thus a precipitate was precipitated. The precipitate was obtained by filtration, and then washed with ethyl acetate. Subsequently, ion exchange was carried out on the precipitate with 1 L of 1 M KBr aqueous solution, and thus an ion exchange product was obtained. Subsequently, the ion exchange product was dried to obtain an anion exchange resin.

In the operation S6, the anion exchange resin was dissolved in dimethyl sulfoxide (DMSO) to obtain a homogeneous solution with a solid content of 20 wt %. The homogeneous solution was casted into a membrane coating machine to obtain a semi-finished product. The semi-finished product was dried at 60° C. for 8 h to obtain a dried membrane. Then the dried membrane was soaked in 1 M KOH at 60° C. for 48 h to produce an anion exchange membrane.

In the present embodiment, different examples were set up by taking types of the monomer I, the monomer II, and the monomer III as variables. Based on the specific monomers I and II selected in different examples, the reaction temperatures and reaction durations of the oligomerization reaction involved in the operation S2, and the reaction temperatures and reaction durations of the high-polymerization reaction involved in the operation S3 in the preparation of the anion exchange membrane are adaptively adjusted. The variables among Examples 1-10 are shown in Table 1. Except for the variables shown in Table 1, all other experimental operations and raw materials in Examples 1-10 in this embodiment are strictly consistent with each other.

TABLE 1
variables among Examples 1-10

| | | | | oligomerization reaction | | high-polymerization reaction | |
|---|---|---|---|---|---|---|---|
| group | monomer I | monomer II | monomer III | temperature | duration | temperature | duration |
| Ex. 1 | p-terphenyl | 1,3,5- | 3-quinuclidinone | 0° C. | 1.5 h | 10° C. | 2 h |
| | | triphenylbenzene | | | | | |
| Ex. 2 | p-terphenyl | triptycene | 3-quinuclidinone | 0° C. | 1.5 h | 10° C. | 2.5 h |
| Ex. 3 | p-terphenyl | triphenylmethane | N-methyl-4- | 0° C. | 1.5 h | 10° C. | 5 h |
| | | | piperidone | | | | |
| Ex. 4 | p-terphenyl | triphenylamine | N-methyl-4- | 0° C. | 1.5 h | 10° C. | 4.5 h |
| | | | piperidone | | | | |
| Ex. 5 | p-terphenyl | 9,9′-spirobi[9H- | N-methyl-4- | 0° C. | 1.5 h | 10° C. | 3 h |
| | | fluorene] | piperidone | | | | |
| Ex. 6 | m-terphenyl | 1,3,5- | N-methyl-4- | 0° C. | 1 h | 10° C. | 3 h |
| | | triphenylbenzene | piperidone | | | | |
| Ex. 7 | m-terphenyl | triptycene | 3-quinuclidinone | 0° C. | 1 h | 10° C. | 4 h |
| Ex. 8 | m-terphenyl | triphenylmethane | N-methyl-4- | 0° C. | 1 h | 10° C. | 5 h |
| | | | piperidone | | | | |
| Ex. 9 | m-terphenyl | triphenylamine | N-methyl-4- | 0° C. | 1 h | 10° C. | 5.5 h |
| | | | piperidone | | | | |
| Ex. 10 | m-terphenyl | 9,9′-spirobi[9H- | 3-quinuclidinone | 10° C. | 1 h | 10° C. | 4 h |
| | | fluorene] | | | | | |

Serial numbers of anion exchange resins produced in the above examples are specifically shown in Table 2. Table 2 shows weight-average molecular weight and polydispersity index (PDI) of the nitrogen-containing branched polymers obtained after the operation S4 in the process of preparing the anion exchange resins in the above examples.

TABLE 2
nitrogen-containing branched polymers and anion
exchange resins produced in Examples 1-10

| | | nitrogen-containing branched polymer | |
|---|---|---|---|
| | | weight-average | polydis- |
| | | molecular | persity |
| group | anion exchange resin | weight(g/mol) | index |
| Ex. 1 | anion exchange resin A | 101431 | 1.97 |
| Ex. 2 | anion exchange resin B | 78102 | 1.83 |
| Ex. 3 | anion exchange resin C | 81236 | 1.85 |
| Ex. 4 | anion exchange resin D | 85690 | 1.89 |
| Ex. 5 | anion exchange resin E | 68513 | 1.73 |
| Ex. 6 | anion exchange resin F | 61220 | 1.69 |
| Ex. 7 | anion exchange resin G | 49801 | 1.66 |
| Ex. 8 | anion exchange resin H | 53419 | 1.7 |
| Ex. 9 | anion exchange resin I | 56221 | 1.79 |
| Ex. | anion exchange resin J | 45543 | 1.6 |
| 10 | | | |

The anion exchange resins shown in Table 2 and corresponding chemical structures are listed as follows specifically. The anion exchange resin A is

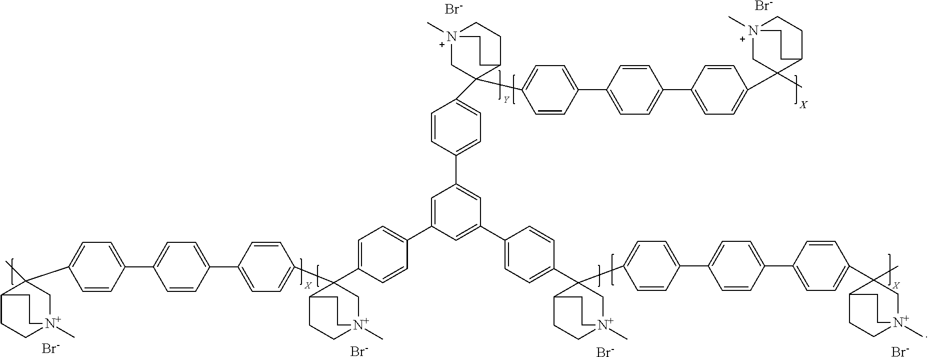

The anion exchange resin B is

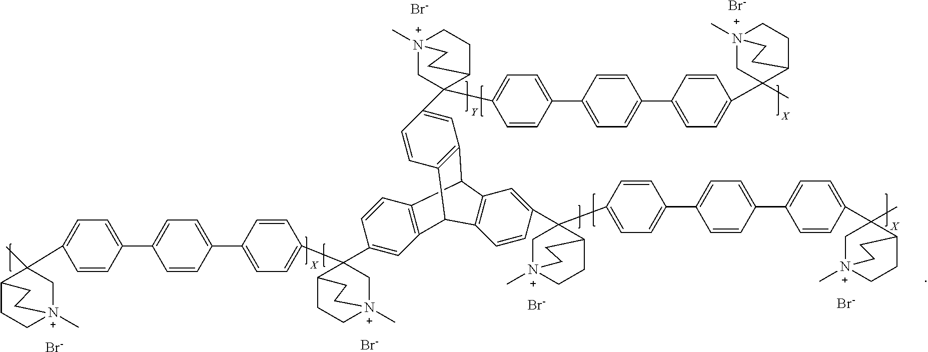

The anion exchange resin C is

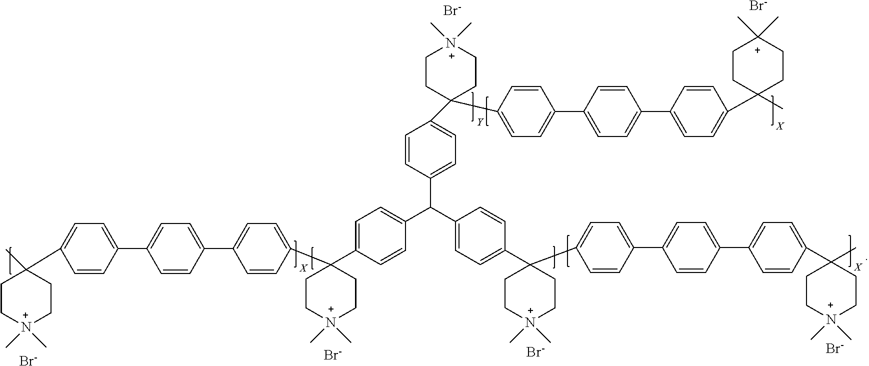

The anion exchange resin Dis

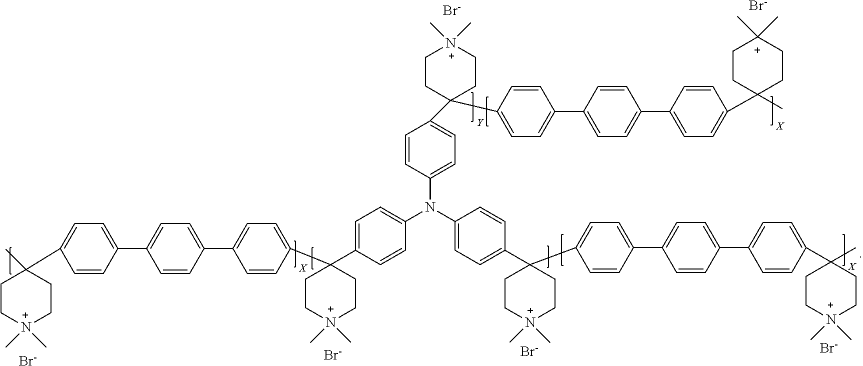

The anion exchange resin E is

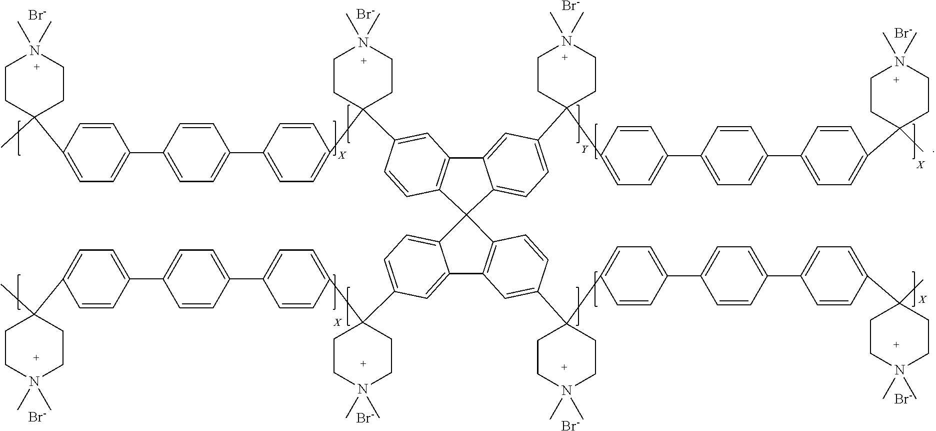

The anion exchange resin F is

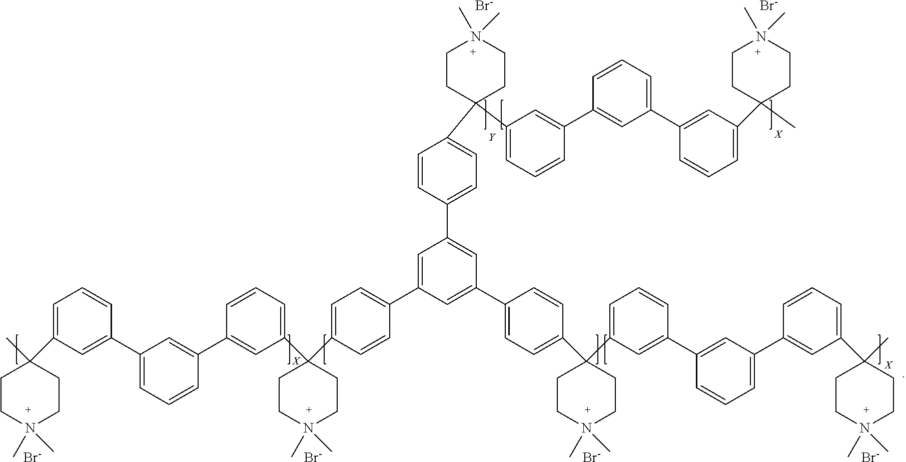

The anion exchange resin Gis

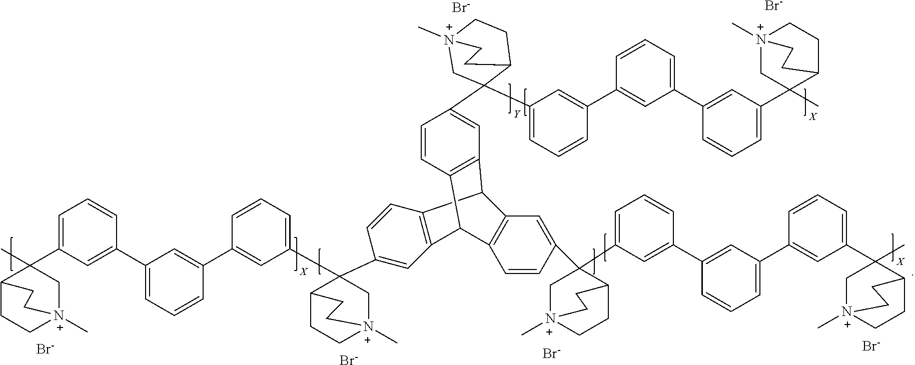

The anion exchange resin H is

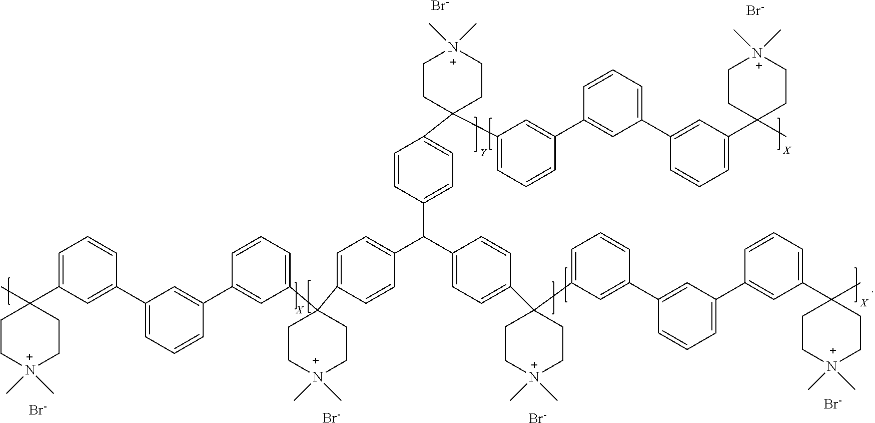

The anion exchange resin I is

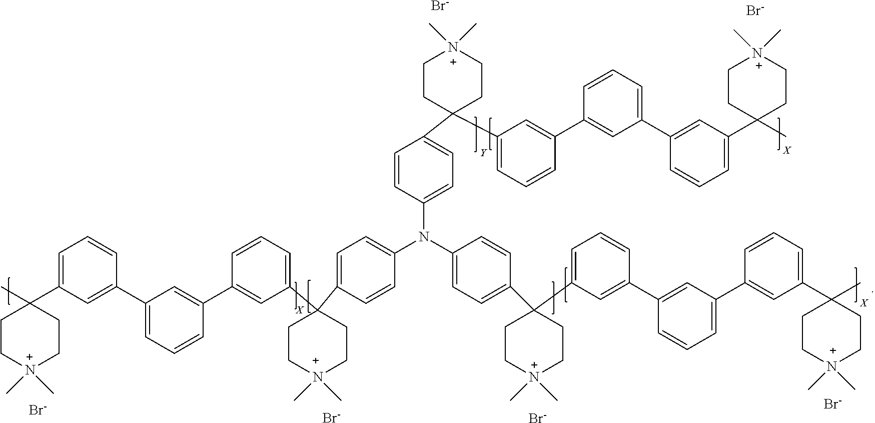

The anion exchange resin J is

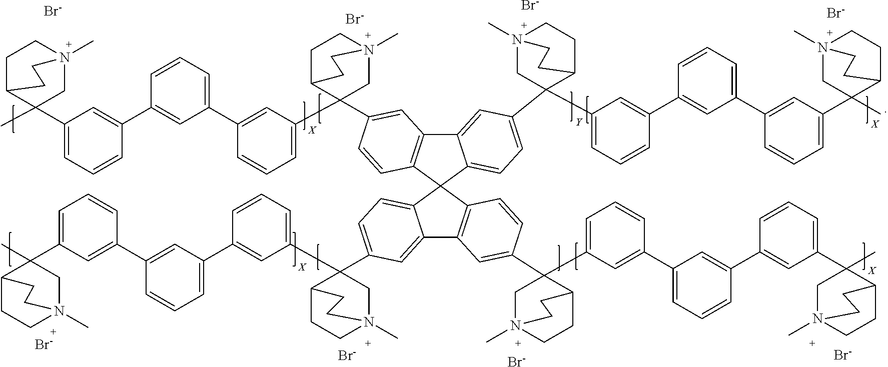

### Test Example 1

### 1. Test Objects

In this test example, anion exchange resins and anion exchange membranes produced in Examples 1-10 were taken as test objects.

### 2. Test Items and Test Methods

### (1) Solubility Test

The anion exchange resin to be tested was dissolved in a certain amount of dimethyl sulfoxide at 80° C., and solubility of the anion exchange resin in 24 h was obtained.

Solubility Rating Criteria: freely soluble, marked as “++”; sparingly soluble, marked as “−+”; insoluble, marked as “−”.

### (2) Mechanical Property Test

### Test Method:

Under a constant temperature and humidity condition with a temperature of 23° C.±2° C. and a relative humidity of 50%±10%, a thickness and a width of the anion exchange membrane to be tested were measured. The anion exchange membrane to be tested was placed in a test fixture for testing a tensile strength and an elongation at break. When the anion exchange membrane was tested for the tensile strength and the elongation at break, different tensile speeds could be selected from a range of 50 mm/min-200 mm/min. For one sample, only one tensile speed was adopted. After the sample broke, a corresponding load value was recorded.
a. Tensile Strength: The tensile strength was a ratio of the maximum load that the anion exchange membrane to be tested could bear when it broke under an action of a pure tensile force to a width of the anion exchange membrane to be tested, which included a transverse tensile strength and a longitudinal tensile strength and was used to evaluate a mechanical strength of the anion exchange membrane to be tested.
b. Elongation at Break: The elongation at break was a ratio of a distance between two points where the anion exchange membrane to be tested broke under the maximum load it was subjected to before it was broken to an original distance between the two points. The ratio represented the maximum deformation that the anion exchange membrane to be tested could bear before being stretched to break and was used to represent flexibility of the anion exchange membrane.

### (3) Water Absorption and Swelling Properties Test

### Test Method:

a. The anion exchange membrane to be tested was cut into a size of 1 cm×4 cm, and put into 1 M KOH for alkali exchange three times, and then subjected to the swelling property test in deionized water at 80° C.
b. The anion exchange membrane to be tested was cut into a size of 5 cm×5 cm, and put into 1 M KOH for alkali exchange three times, and then subjected to the swelling property test in deionized water at 80° C.
   (4) OH⁻ Ionic Conductivity Test (Conductivity Test Membrane State: OH⁻ @ 80° C. @ Pure Water)

The anion exchange membrane to be tested was cut into a size of 10 mm×45 mm as a sample. The sample was put into 1 M KOH aqueous solution and subjected to ion exchange at 80° C. for 24 h. After the ion exchange was completed, the sample was washed with deionized water until the deionized water was neutral and then the sample was stored in the deionized water. Before the test, a thickness b of the anion exchange membrane to be tested was measured by a thickness gauge, and a width a of the anion exchange membrane to be tested was measured by a ruler. Both the thickness b and the width a were measured by a method of taking an average value of three measurements.

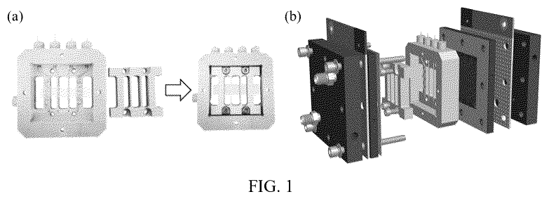

An ionic conductivity test device is shown in FIG. 1, and a four-electrode probe method was adopted for the test. Firstly, the sample was flat laid above a platinum wire electrode without wrinkles to ensure good contact between the sample and the platinum wire electrode. An upper cover was gently placed and the screws were tightened with a wrench. After the screws were tightened, there should be no protrusion on the sample, and then assembly of a test module was completed.

The test fixture was connected to a temperature and humidity control system. Then N2 (99.999%, the same below) was purged, and a flow rate on each of both sides was set to 500 sccm. A humidification condition was set to 100% RH, and it was ensured that a temperature of a pipeline was 5° C. higher than that of the ionic conductivity test device. An actual test temperature was set according to requirements. Then a temperature and humidity device was started, and an electrolysis process was started after the set conditions were reached. Purging with N2 was kept throughout the test with a gas flow rate unchanged.

### (5) Electrolyzed Water Test

The anion exchange membrane to be tested was electrolyzed by means of a constant-current method. An electrolysis current value could be adjusted within an electrolysis potential of 2V to meet actual test requirements. During an electrolysis process, the electrodes were subjected to an electrochemical reaction, so that carbonate (hydrogen) root ions in the anion exchange membrane were discharged in a form of CO₂ gas until all anions in the membrane were exchanged in-situ to OH⁻. Whether the electrolysis reached equilibrium was judged according to an over-potential change during the test process. Generally, when a potential fluctuation value was less than 1% during the electrolysis process, it was determined that the electrolysis process was over and the system had reached an equilibrium state.

a. EIS Test Process

After the electrolysis reached equilibrium, an EIS test was conducted, with a current perturbation mode selected, a frequency range being 0.1 Hz-1.0 MHz, a perturbation amplitude being 1 mA, to obtain an impedance spectrum. An impedance value R of the anion exchange membrane from an intersection of a low-frequency part and a real axis of the spectrum was obtained, and then an in-plane ionic conductivity of the sample was calculated according to the following formula: σ=l/(a×b×R).

In detail, σ represents the in-plane ionic conductivity of the sample, with a unit of millisiemens per centimeter (mS/cm), 1 represents a distance between anode and cathode, with a unit of centimeter (cm), a represents a width of the sample, with a unit of centimeter (cm), b represents a thickness of the sample, with a unit of centimeter (cm), and R represents a measuring impedance of the sample, with a unit of ohm (Ω).

b. Polarization Performance Test

Under a nickel ferrite-anodic and platinum carbon-cathodic catalytic system at 60° C. in 1 M KOH, an alkaline membrane single cell was tested for a polarization curve.

c. Hydrogen in Oxygen Test

A GC online test was conducted on oxygen at the anode to obtain hydrogen in oxygen data.

### 3. Test Results

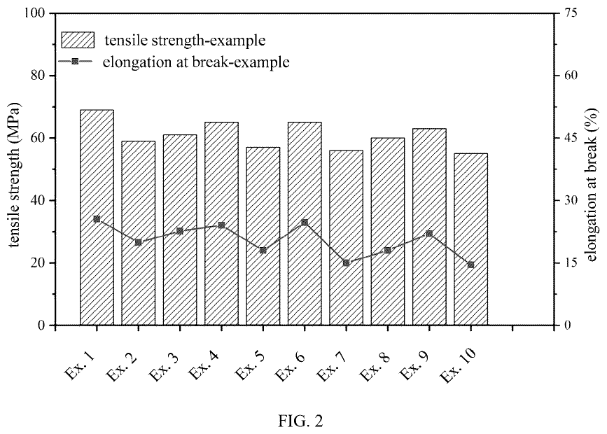

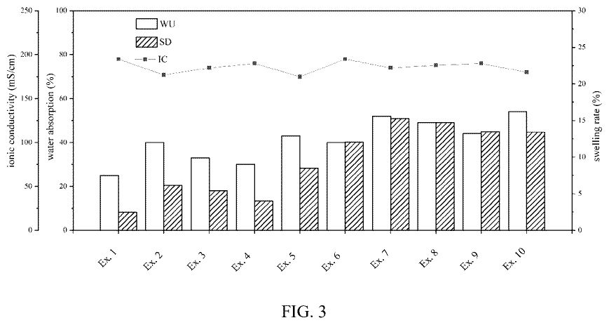

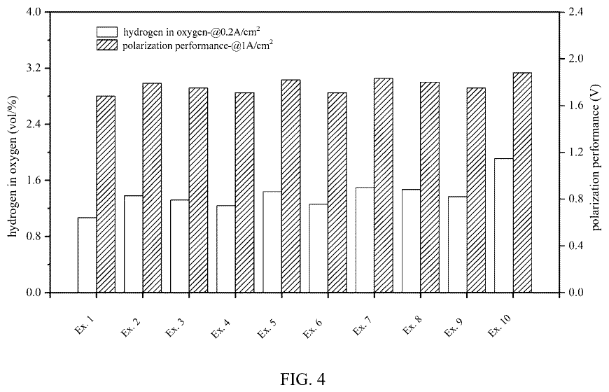

The test results of this test example are listed in Table 3 and Table 4. FIG. 2 was made based on the data in Table 3. FIG. 2 shows a comparison of the tensile strength and elongation at break of the test objects in this test example. Based on the data in Table 4, FIG. 3 and FIG. 4 were made. FIG. 3 shows a comparison of the ionic conductivity, water absorption rate, and swelling rate of the test objects in this test example, and FIG. 4 shows a comparison of the hydrogen in oxygen content and polarization performance of the alkaline membrane single cells applying the test objects in this test example.

It can be seen from the test results that the anion exchange resin prepared in Example 1 simultaneously had a relatively high level on each of the tensile strength and elongation at break, a relatively low level on the swelling rate, and a relatively high level on the ionic conductivity. It shows that the anion exchange resin prepared in Example 1 simultaneously possessed good structural stability, ionic conductivity, and anti-swelling property. When the above-mentioned anion exchange resin was further applied to the electrolyzed water test, based on the above-mentioned superior properties, transmembrane transport of hydrogen generated during an operation of the electrolyzed water system applying the above-mentioned anion exchange resin can be inhibited. Thus, the hydrogen in oxygen in the electrolyzed water system could be controlled at a relatively low level, ensuring working safety of the electrolyzed water system. In addition, the electrolyzed water system could maintain a good ion-transfer effect, improving electrochemical working efficiency.

By a further comparison of the test results of this test example, on the selection of raw materials, the following examples form pairwise control examples, particularly, Example 2 and Example 7, Example 3 and Example 8, and Example 4 and Example 9. A difference between the pairwise control examples lay in the type of the monomer I. Through the comparison, among the above-mentioned pairwise control examples, when p-terphenyl was adopted as the monomer I for preparing the anion exchange resin, related performances of a corresponding produced anion exchange resin were better.

TABLE 3
test results of performances of anion exchange resins and anion exchange membranes

| | | tensile strength | elongation at | water absorption | swelling | ionic |
|---|---|---|---|---|---|---|
| group | solubility | (MPa) | break (%) | rate (%) | rate (%) | conductivity(mS/cm) |
| Ex. 1 | ++ | 69 | 25.5 | 25 | 2.5 | 195 |
| Ex. 2 | −+ | 59 | 19.9 | 40 | 6.1 | 177 |
| Ex. 3 | ++ | 61 | 22.6 | 33 | 5.4 | 185 |
| Ex. 4 | ++ | 65 | 24 | 30 | 4 | 190 |
| Ex. 5 | −+ | 57 | 18 | 43 | 8.5 | 175 |
| Ex. 6 | ++ | 65 | 24.7 | 40 | 12.1 | 195 |
| Ex. 7 | ++ | 56 | 15 | 52 | 15.3 | 185 |
| Ex. 8 | ++ | 60 | 18 | 49 | 14.7 | 188 |
| Ex. 9 | ++ | 63 | 22 | 44 | 13.5 | 190 |
| Ex. 10 | ++ | 55 | 14.5 | 54 | 13.4 | 180 |

TABLE 4
test results of performances of anion exchange
membranes in electrolyzed water application

| | | polarization | internal |
|---|---|---|---|
| | hydrogen in oxygen | performance | resistance |
| group | (vol/%)@0.2 A/cm2 | (V@1 A/cm2) | (Ωcm2) |
| Ex. 1 | 1.07 | 1.68 | 0.118 |
| Ex. 2 | 1.38 | 1.79 | 0.162 |
| Ex. 3 | 1.32 | 1.75 | 0.157 |
| Ex. 4 | 1.24 | 1.71 | 0.142 |
| Ex. 5 | 1.44 | 1.82 | 0.177 |
| Ex. 6 | 1.26 | 1.71 | 0.147 |
| Ex. 7 | 1.5 | 1.83 | 0.174 |
| Ex. 8 | 1.47 | 1.8 | 0.164 |
| Ex. 9 | 1.37 | 1.75 | 0.151 |
| Ex. 10 | 1.91 | 1.88 | 0.183 |

### Examples 11-16, Comparative Examples 1-2

In this embodiment, Examples 11-16, Comparative Examples 1-2 were set up by taking Example 1 and Example 4 as a reference, with the ratio of the monomers adopted in the process of preparing anion exchange membranes as a variable, so as to present influence of the ratio of the monomers on the performances of anion exchange resins and anion exchange membranes.

### (1) Referring to Example 1

Examples 11-14 were designed with reference to Example 1. The variables among these examples were a feeding amount of p-terphenyl and a feeding amount of 1,3,5-triphenylbenzene taken during the process of preparing anion exchange membranes. The feeding amount of p-terphenyl and the feeding amount of 1,3,5-triphenylbenzene taken in these examples are shown in table 5. Except for the variables shown in Table 5, other experimental operations and raw materials taking in the above examples were strictly the same as those in Example 1.

TABLE 5
feeding amount of p-terphenyl and feeding amount of
1,3,5-triphenylbenzene in Examples 1, and 11-14

| | feeding amount of p- | feeding amount of 1,3,5- |
|---|---|---|
| group | terphenyl (mol) | triphenylbenzene (mol) |
| Ex. 1 | 0.27 | 0.03 |
| Ex. 11 | 0.285 | 0.015 |
| Ex. 12 | 0.255 | 0.045 |
| Ex. 13 | 0.291 | 0.009 |
| Ex. 14 | 0.246 | 0.054 |

### (2) Referring to Example 4

Examples 15-16, Comparative Examples 1-2 were designed with reference to Example 4. The variables among these Examples and Comparative Examples were the feeding amount of p-terphenyl and the feeding amount of triphenylamine taken during the process of preparing anion exchange membranes. The feeding amount of p-terphenyl and the feeding amount of triphenylamine taken in each of the above examples and comparative examples are shown in Table 6. Except for the variables shown in Table 6, other experimental operations and raw materials taking in the above examples and comparative examples were strictly the same as those in Example 4.

TABLE 6
feeding amount of p-terphenyl and feeding amount of triphenylamine
in Examples 4, 15-16, and Comparative Examples 1-2

| | feeding amount of | feeding amount of |
|---|---|---|
| group | p-erphenyl (mol) | triphenylamine (mol) |
| Ex. 4 | 0.27 | 0.03 |
| Ex. 15 | 0.285 | 0.015 |
| Ex. 16 | 0.255 | 0.045 |
| Comp. Ex. 1 | 0.291 | 0.009 |
| Comp. Ex. 2 | 0.246 | 0.054 |

For the above-mentioned examples and comparative examples, the weight-average molecular weight and polydispersity index (PDI) of the nitrogen-containing branched polymers obtained in the operation S4 in the process of preparing anion exchange resins are shown in Table 7. For the convenience of comparison, the weight-average molecular weight and PDI of the nitrogen-containing branched polymers prepared in Examples 1 and 4 are also listed in Table 7.

TABLE 7
weight-average molecular weight and PDI of nitrogen-
containing branched polymers prepared in Examples
1, 4, and 11-16 and Comparative Examples 1-2

| | weight-average | |
|---|---|---|
| group | molecular weight (g/mol) | PDI |
| Ex. 1 | 101431 | 1.97 |
| Ex. 11 | 94145 | 1.85 |
| Ex. 12 | 123805 | 2.1 |
| Ex. 13 | 40674 | 1.8 |
| Ex. 14 | 134503 | 2.55 |
| Ex. 4 | 85690 | 1.89 |
| Ex. 15 | 81802 | 1.83 |
| Ex. 16 | 89012 | 1.93 |
| Comp. Ex. 1 | 35623 | 1.77 |
| Comp. Ex. 2 | 92351 | 2.76 |

### Test Example 2

### 1. Test Objects

In this test example, anion exchange resins and anion exchange membranes prepared in Examples 11-16 and Comparative Examples 1-2 were taken as test objects.

### 2. Test Items and Test Methods

The test items in this test example are listed as follows. The test method for each test item in this test example was consistent with a test method for a corresponding test item in Test Example 1.
(1) Solubility Test
(2) Mechanical Property Tests
a. Tensile Strength
b. Elongation at Break
(3) Water Absorption and Swelling Properties Test
(4) O⁻ Ionic Conductivity (conductivity test membrane state: OH⁻ @80° C.@ pure water)
(5) Electrolyzed Water Test
a. EIS Test Process

### 3. Test Results

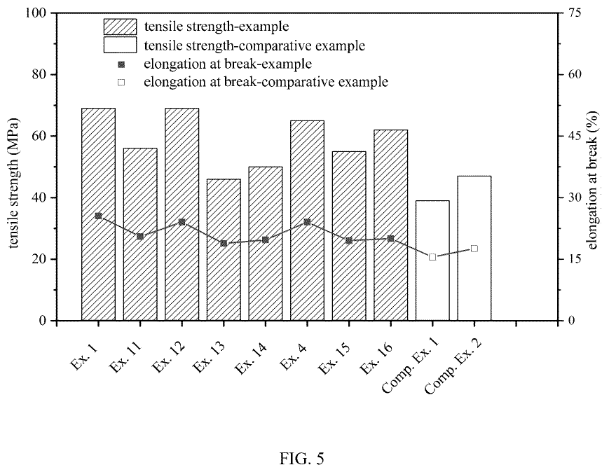

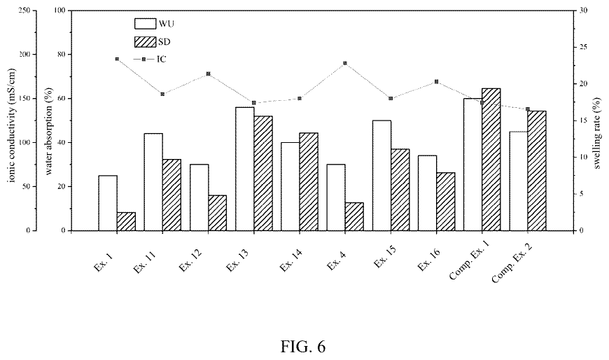

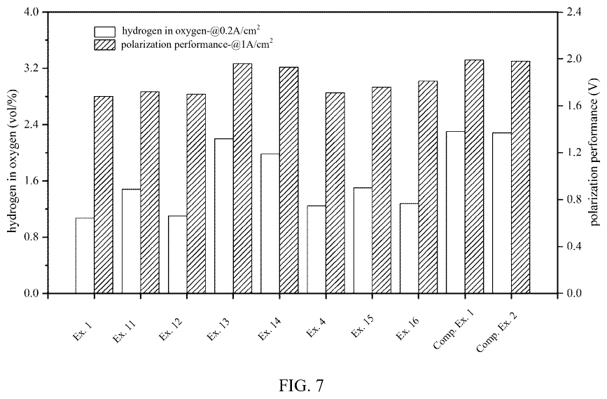

The test results of this test example are listed in Tables 8-9. Based on the data in Table 8, FIG. 5 was made. FIG. 5 shows a comparison of the tensile strength and elongation at break of the test objects in this test example. Based on the data in table 9, FIGS. 6-7 were made. FIG. 6 shows a comparison of the ionic conductivity, water absorption rate, and swelling rate of the test objects in this test example, and FIG. 7 shows a comparison of the hydrogen in oxygen content and polarization performance of the alkaline membrane single cells applying the test objects in this test example.

By comparing the test results of the test objects provided by Example 1 with those provided by Examples 11-14, and comparing the test results of the test objects provided by Example 4 with those provided by Examples 15-16, and Comparative Examples 1-2, the influence of the ratio of the monomer I and the monomer II on the performances of anion exchange resins and anion exchange membranes can be presented. Combined with data shown in Table 7, on the premise of the same type of raw materials, the ratio of the monomer I and the monomer II can change the weight-average molecular weight and polydispersity index (PDI) of the nitrogen-containing branched polymers. In Examples 11-16 and Comparative Examples 1-2, the weight-average molecular weight of the nitrogen-containing branched polymer produced in Comparative Example 1 is relatively low, and lower than 40,000 g/mol, and the polydispersity index (PDI) of the nitrogen-containing branched polymer produced in comparative Example 2 is relatively high, and higher than 2.6. As shown in table 8, the ionic conductivity of the anion exchange resin prepared in Comparative Example 1 is relatively low, while the anion exchange resin prepared in Comparative Example 2 has relatively low tensile strength, relatively low elongation at break, and relatively high swelling rate, and the anion exchange resins prepared in Examples 11-16 all have relatively high tensile strength, relatively high elongation at break, relatively low swelling rate, and relatively high ionic conductivity. It can be seen that when the nitrogen-containing branched polymer adopted to prepare the anion exchange resin fails to simultaneously satisfy that the weight-average molecular weight is not less than 40,000 g/mol and the polydispersity index (PDI) is not greater than 2.6, it is difficult for corresponding anion exchange resin to overcome the trade-off effect among the ionic conductivity, structural stability, and water absorption and swelling properties.

According to the analysis of the above test results, the anion exchange resins respectively prepared in Examples 11-14 and Comparative Examples 1-2 all have relatively high ionic conductivity, good structural stability, and relatively low water absorption and swelling properties. On this basis, by comparing the test results of the above examples and comparative examples with those of Example 1 which was taken as a reference, it can be seen that in the process of preparing anion exchange resins, when a feeding molar ratio of monomer I to monomer II meets 85-95:5-15, it is more likely that the produced nitrogen-containing branched polymers can simultaneously meet the weight-average molecular weight not less than 40,000 g/mol and the polydispersity index of PDI≤2.6.

TABLE 8
test results of performances of anion exchange resins and anion exchange membranes

| | | tensile strength | elongation at | water absorption | swelling | ionic conductivity |
|---|---|---|---|---|---|---|
| group | solubility | (MPa) | break (%) | rate (%) | rate (%) | (mS/cm) |
| Ex. 1 | ++ | 69 | 25.5 | 25 | 2.5 | 195 |
| Ex. 11 | ++ | 56 | 20.5 | 44 | 9.7 | 155 |
| Ex. 12 | −+ | 69 | 24 | 30 | 4.8 | 178 |
| Ex. 13 | ++ | 46 | 18.8 | 56 | 15.6 | 145 |
| Ex. 14 | −+ | 50 | 19.7 | 40 | 13.3 | 150 |
| Ex. 4 | ++ | 65 | 24 | 30 | 3.8 | 190 |
| Ex. 15 | ++ | 55 | 19.5 | 50 | 11.1 | 150 |
| Ex. 16 | ++ | 62 | 20 | 34 | 7.9 | 169 |
| Comp. Ex. 1 | ++ | 39 | 15.5 | 60 | 19.4 | 145 |
| Comp. Ex. 2 | −+ | 47 | 17.6 | 45 | 16.3 | 138 |

TABLE 9
test results of performances of anion exchange
membranes in electrolyzed water application

| | | polarization | internal |
|---|---|---|---|
| | hydrogen in oxygen | performance | resistance |
| group | (vol/%)@0.2 A/cm2 | (V@1 A/cm2) | (Ωcm2) |
| Ex. 1 | 1.07 | 1.68 | 0.118 |
| Ex. 11 | 1.48 | 1.72 | 0.13 |
| Ex. 12 | 1.1 | 1.7 | 0.121 |
| Ex. 13 | 2.2 | 1.96 | 0.185 |
| Ex. 14 | 1.98 | 1.93 | 0.181 |
| Ex. 4 | 1.24 | 1.71 | 0.142 |
| Ex. 15 | 1.5 | 1.76 | 0.15 |
| Ex. 16 | 1.28 | 1.81 | 0.145 |
| Comp. Ex. 1 | 2.3 | 1.99 | 0.19 |
| Comp. Ex. 2 | 2.28 | 1.98 | 0.184 |

### Examples 17, Comparative Examples 3-6

In this embodiment, Examples 1-5 are taken as controls to design other examples and comparative examples to prepare anion exchange membranes. The types of monomers I and II used in related examples for preparing anion exchange membranes were the same. The comparison in examples and comparative examples and related methods adopted for preparing anion exchange membranes are specifically described below.

### (1) Example 17

Taking Example 1 as a reference, the method for preparing an anion exchange membrane in Example 17 included the following operations S1 to S4.

In the operation S1, 0.27 mol of p-terphenyl, 0.03 mol of 1,3,5-triphenylbenzene, and 0.36 mol of 3-quinuclidinone hydrochloride were added and dissolved into 100 mL of dichloromethane to obtain a mixture. The mixture was stirred at 0° C., and 240 mL of trifluoromethanesulfonic acid and 22.8 mL of trifluoroacetic acid were simultaneously slowly added dropwise to the mixture. After the addition was completed, the mixture was stirred continuously for 72 h to obtain a viscous solution. The viscous solution was successively washed with pure water, 1 mol of NaOH aqueous solution, and pure water, and then dried at 100° C. for 30 h to obtain a nitrogen-containing branched polymer in a form of a pale-yellow powder.

In the operation S2, 0.1 mol of the nitrogen-containing branched polymer obtained in the operation S1 and 0.15 mol of iodomethane were added and dissolved into dimethyl sulfoxide to obtain a mixture. The mixture was stirred at 60° C. for 10 h for reaction. After the reaction is completed, the resulting product was washed three times with pure water, and then dried at 100° C. for 30 h to obtain an anion exchange resin in the form of a pale-yellow powder.

In the operation S3, the anion exchange resin was added and dissolved into N,N-dimethylacetamide to obtain a polymer solution. The polymer solution was coated on a glass plate, and then dried in an oven at 80° C. for 5 h, and then a temperature in the oven was raised to 120° C. and the coated glass plate coated with the polymer solution was dried continuously for 20 h to obtain an iodide ion exchange membrane.

In the operation S4, the iodide ion exchange membrane was soaked in 1 M NaOH aqueous solution for 5 h at room temperature. Subsequently, the iodide ion exchange membrane was taken out and washed with pure water, and then dried in an oven at 100° C. for 5 h under a nitrogen atmosphere to obtain an anion exchange membrane.

### (2) Comparative Example 3

Taking Example 2 as a reference, the method for preparing an anion exchange membrane in Comparative Example 3 included the following operations S1 to S4.

In the operation S1, 0.27 mol of p-terphenyl, 0.03 mol of triptycene, 0.36 mol of 3-quinuclidone, and 100 mL of dichloromethane were mixed together by adding the 0.27 mol of p-terphenyl, 0.03 mol of triptycene, and 0.36 mol of 3-quinuclidone to 100 mL of dichloromethane, then stirred for 10 min with a magnetic stirrer in an ice-water bath under an air atmosphere to obtain a pale-yellow mixed solution. Then, 240 mL of trifluoromethanesulfonic anhydride (TFSA) was added dropwise to the above-mentioned mixed solution to obtain a mixture. After the addition is completed, the mixture was stirred for 36 h for reaction, and then a viscous solution was obtained. The obtained viscous solution was poured into a mixed solution of 200 ml of water with 200 mL of methanol to precipitate a yellow polymer. The above-mentioned yellow polymer was scattered by stirring, filtered, and collected. Subsequently, the collected yellow polymer was stirred and washed with a 1 M K₂CO₃ solution at room temperature for 12 h to neutralize residual acid, then washed three times with deionized water, and finally dried in a vacuum oven at 80° C. for 12 h to produce a nitrogen-containing branched polymer.

In the operation S2, a mixture was obtained by dissolving 0.1 mol of the polymer obtained in the operation S1 was dissolved in 30 mL of DMSO. The mixture was stirred at room temperature for 30 min, then K₂CO₃ and 0.15 mol of iodomethane were added to the mixture, then stirred in the dark at room temperature for 12 h, then heated to 60° C., and stirred for 6 h to obtain a viscous solution. Subsequently, 200 mL of ether was added to the obtained viscous solution to precipitate a yellow precipitate. The yellow precipitate was filtered, washed three times with deionized water, and dried in a vacuum oven at 80° C. for 12 h to obtain an anion exchange resin.

In the operation S3, the anion exchange resin obtained in the operation S2 was dissolved in 15 mL of DMSO to obtain a polymer solution. The polymer solution was filtered through a 0.45 μm polytetrafluoroethylene (PTFE) filter, and then casted on a glass plate. Subsequently, the glass plate was dried on a solvent-evaporation heating platform at 120° C. for 6 h. After residual solvent was completely removed, a type-I polymer membrane with a thickness of 40 μm was obtained.

In the operation S4, the type-I polymer membrane was soaked in 1 M KOH solution to obtain an OH-membrane, and then the OH-membrane was washed three times with deionized water to finally produce an anion exchange membrane.

### (3) Comparative Example 4

Taking Example 3 as a reference, the method for preparing an anion exchange membrane in Comparative Example 4 included the following operations S1 to S3.

In the operation S1, 0.27 mol of p-terphenyl, 0.03 mol of triphenylmethane, 0.36 mol of N-methyl-4-piperidone, and 100 mL of dichloromethane were mixed together by adding and dissolving 0.27 mol of p-terphenyl, 0.03 mol of triphenylmethane, and 0.36 mol of 1-methylpiperidine-4-carbaldehyde into 100 mL of dichloromethane, then stirred for 10 min with a magnetic stirrer in an ice-water bath under an air atmosphere to obtain a pale-yellow mixed solution. Then, 240 mL of TFSA was added dropwise to the above-mentioned mixed solution to obtain a mixture. After the addition is completed, the mixture was stirred for 1 h for reaction, and then a viscous solution was obtained. The obtained viscous solution was poured into a mixed solution of 200 ml of water with 200 mL of methanol to precipitate a pale-yellow polymer. The above-mentioned yellow polymer was scattered by stirring to some fragments, and then the fragments were filtered and collected. Subsequently, the collected fragments were stirred and washed with a 1 M K₂CO₃ solution at room temperature for 12 h to neutralize residual acid, and then washed three times with deionized water, and finally dried in a vacuum oven at 80° C. for 12 h to produce a nitrogen-containing branched polymer.

In the operation S2, a mixture was obtained by dissolving 0.1 mol of the nitrogen-containing branched polymer in DMSO, and stirred at room temperature for 30 min. Then K₂CO₃ and 0.15 mol of iodomethane were added to the mixture, then stirred in the dark at room temperature for 12 h, then heated to 60° C. and stirred for 6 h to obtain a viscous solution. Subsequently, 200 mL of ether was added to the obtained viscous solution to precipitate a yellow precipitate. The yellow precipitate was filtered, washed three times with deionized water, and dried in a vacuum oven at 80° C. for 12 h to obtain an anion exchange resin.

In the operation S3, 0.4 g of the anion exchange resin was dissolved in 15 mL of DMSO to obtain a polymer solution. The polymer solution was filtered through a 0.45-μm polytetrafluoroethylene (PTFE) filter, and then casted on a glass plate. Subsequently, the glass plate was dried on a solvent-evaporation heating platform at 120° C. for 6 h. After residual solvent was completely removed, a type-I polymer membrane with a thickness of 40 μm was obtained. The type-I polymer membrane was soaked in 1 M KOH solution, and subjected to ion exchange at 60° C. for 12 h to obtain an OH-membrane, and then the OH-membrane was washed three times with deionized water to finally produce an anion exchange membrane.

### (4) Comparative Example 5

Taking Example 4 as a reference, the method for preparing an anion exchange membrane in Comparative Example 5 included the following operations S1 to S3.

In the operation S1, 0.27 mol of p-terphenyl was added to a 250-mL three-necked flask, then 100 mL of dichloromethane solution was added, and then 0.36 mol of N-methyl-4-piperidone and 0.03 mol of triphenylamine were further added to obtain a mixture. After the mixture was mechanically stirred for a while, 22.8 mL of trifluoroacetic acid and 240 mL of trifluoromethanesulfonic acid were slowly added to the 250-mL three-necked flask under an ice-bath condition to obtain a reaction solution for reaction. The reaction took 4 h, and during the reaction, the ice-bath condition was maintained. When the reaction solution became highly viscous, the reaction solution was poured into methanol to precipitate a crude polymer product, then the crude polymer product was washed with deionized water until the crude polymer was neutral, and then dried at 60° C. for 24 h to obtain a nitrogen-containing branched polymer.

In the operation S2, 0.1 mol of the nitrogen-containing branched polymer was weighed and then added and dissolved into 200 mL of dimethyl sulfoxide to obtain a mixture. Subsequently, potassium carbonate and 0.15 mol of iodomethane were added to the mixture for reaction in the dark at room temperature for about 36 h to obtain a solution. The solution was poured into ethyl acetate to precipitate a solid powder-like product. The solid powder-like product was filtered, dried, and then washed multiple times with deionized water to remove unreacted salts, and finally dried at 60° C. for 24 h to obtain an anion exchange resin.

In the operation S3, 0.05 g of the anion exchange resin was weighed, and then added and dissolved into 5 mL of dimethyl sulfoxide to obtain a casting solution. The casting solution was centrifuged, then casted in a glass mold, and dried at 60° C. for 24 h to obtain a polymer membrane. The polymer membrane was soaked in a 1 mol/L NaOH solution at room temperature for 24 h, and then repeatedly washed and soaked with deionized water for 24 h until the polymer membrane was neutral to produce an anion exchange membrane.

### (5) Comparative Example 6

Taking Example 5 as a reference, the method for preparing an anion exchange membrane in comparative Example 6 included the following operations S1 to S3.

In the operation S1, 0.27 mol of p-terphenyl, 0.03 mol of 9,9′-spirobi[9H-fluorene], 0.36 mol of N-methyl-4-piperidone, and 100 mL of dichloromethane were mixed together by adding and dissolving 0.27 mol of p-terphenyl, 0.03 mol of 9,9′-spirobi[9H-fluorene], 0.36 mol of 1-methyl-4-piperidinecarbaldehyde into 100 mL of dichloromethane, then stirred for 10 min with a magnetic stirrer in an ice-water bath under an air atmosphere to obtain a pale-yellow mixed solution. Then, add 240 mL of TFSA was added dropwise to the above-mentioned mixed solution to obtain a mixture. After the addition is completed, the mixture was stirred for 1 h for reaction, and then a viscous solution was obtained. The obtained viscous solution was poured into a mixture solution of 200 ml of water with 200 mL of methanol to precipitate a pale-yellow polymer. The above-mentioned yellow polymer was scattered by stirring to some fragments, and then the fragments were filtered and collected. Subsequently, the collected fragments were stirred and washed with a 1 M K₂CO₃ solution at room temperature for 12 h to neutralize residual acid, and then washed three times with deionized water, and finally dried in a vacuum oven at 80° C. for 12 h to produce a nitrogen-containing branched polymer.

In the operation S2, a mixture was obtained by dissolving 0.1 mol of the nitrogen-containing branched polymer in DMSO, and stirred at room temperature for 30 min. Then K₂CO₃ and 0.15 mol of iodomethane were added to the mixture, then stirred in the dark at room temperature for 12 h, then heated to 60° C. and stirred for 6 h to obtain a viscous solution. Subsequently, 200 mL of ether was added to the obtained viscous solution to precipitate a yellow precipitate. The yellow precipitate was filtered, washed three times with deionized water, and dried in a vacuum oven at 80° C. for 12 h to obtain a quaternization branched anion exchange resin.

In the operation S3, 0.4 g of the anion exchange resin was dissolved in 15 mL of DMSO to obtain a polymer solution. The polymer solution was filtered through a 0.45-μm polytetrafluoroethylene (PTFE) filter, and then casted on a glass plate. Subsequently, the glass plate was dried on a solvent-evaporation heating platform at 120° C. for 6 h. After residual solvent was completely removed, a type-I polymer membrane with a thickness of 40 μm was obtained. The type-I polymer membrane was soaked in 1 M KOH solution, and subjected to ion exchange at 60° C. for 12 h to obtain an OH-membrane, and then the OH-membrane was washed three times with deionized water to finally produce an anion exchange membrane.

The weight-average molecular weight and polydispersity index (PDI) of the nitrogen-containing branched polymers produced in the process of preparing anion exchange resins in Example 17 and Comparative Examples 3-6, are shown in Table 10. Referring to the operations of Example 17 and Comparative Examples 3-6, it can be seen that Example 1 was taken as a reference by the Example 17 and Comparative Examples 3-6. On a basis of adopting the same monomers I and II as those in Example 1, different synthesis methods were adopted to prepare nitrogen-containing branched polymers in Example 17 and Comparative Examples 3-6. By comparing the data shown in Table 10 with the data shown in Table 2, it can be seen that different preparation methods can cause obvious changes in the weight-average molecular weight and polydispersity index (PDI) of the nitrogen-containing branched polymers. Although the nitrogen-containing branched polymers prepared in Comparative Examples 3-6 had an appropriate weight-average molecular weight, the polydispersity index (PDI) of these nitrogen-containing branched polymers was as high as above 2.6.

TABLE 10
weight-average molecular weight and PDI of nitrogen-
containing branched polymers produced in Example
17 and Comparative Examples 3-6

| | weight-average | |
|---|---|---|
| group | molecular weight (g/mol) | PDI |
| Ex. 17 | 65515 | 2.44 |
| Comp. Ex. 3 | 91445 | 2.67 |
| Comp. Ex. 4 | 69910 | 2.61 |
| Comp. Ex. 5 | 83100 | 3.16 |
| Comp. Ex. 6 | 93212 | 2.73 |

### Test Example 3

### 1. Test Objects

In this test example, anion exchange resins and anion exchange membranes produced in Example 17 and Comparative Examples 3-6 were taken as test objects.

### 2. Test Items and Test Methods

The test items in this test example are as follows. The test method for each test item in this test example was consistent with the test method of a corresponding test item in Test Example 1.
(1) Solubility Test
(2) Mechanical Property Tests
a. Tensile Strength
b. Elongation at Break
(3) Water Absorption and Swelling Properties Test
(4) O⁻ Ionic Conductivity (conductivity test membrane state: OH⁻ @80° C.@ pure water)
(5) Electrolyzed Water Test
a. EIS Test Process
b. Polarization Performance Test
c. Hydrogen in Oxygen Test

### 3. Test Results

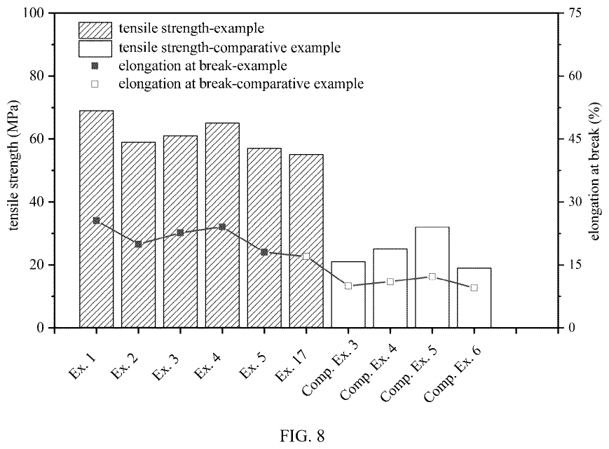

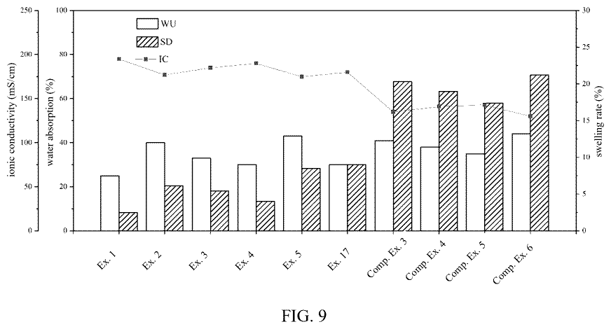

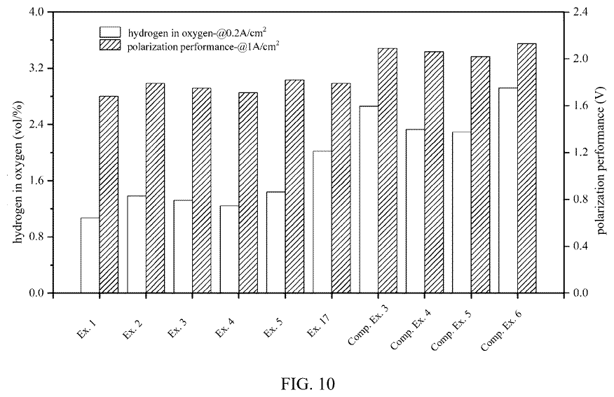

The test results of this test example are recorded in Table 11 and Table 12. FIG. 8 was made based on the data in Table 11. FIG. 8 shows a comparison of tensile strength and elongation at break of the test objects in this test example. FIG. 9 and FIG. 10 were made based on the data in Table 12. FIG. 9 shows a comparison of ionic conductivity, water absorption rate, and swelling rate of the test objects in this test example, and FIG. 10 shows a comparison of a content of the hydrogen in oxygen and polarization performance of the alkaline membrane single cells applying the test objects in this test example.

As mentioned above, when the types of monomers used for preparing nitrogen-containing branched polymers are the same, the preparation method may influence the weight-average molecular weight and polydispersity index (PDI) of the nitrogen-containing branched polymers. The test results of this test example show that among the test objects in this test example, the anion exchange resin prepared in Example 17 had relatively high ionic conductivity, good structural stability, and relatively low water absorption and swelling properties, and had a comprehensive performance significantly better than that of the anion exchange resins prepared in Comparative Examples 3-6. However, comparing the anion exchange resin in Example 17 with the anion exchange resin prepared in Example 1, it can be seen that a comprehensive performance of the anion exchange resin prepared in Example 1 was better.

TABLE 11
test results of performances of anion exchange resins and anion exchange membranes

| | | tensile strength | elongation at | water absorption | swelling | ionic conductivity |
|---|---|---|---|---|---|---|
| group | solubility | (MPa) | break (%) | rate(%) | rate(%) | (mS/cm) |
| Ex. 17 | ++ | 55 | 17 | 30 | 9 | 180 |
| Comp. Ex. 3 | −+ | 21 | 10 | 41 | 20.3 | 135 |
| Comp. Ex. 4 | −+ | 25 | 11 | 38 | 19 | 141 |
| Comp. Ex. 5 | −+ | 32 | 12.2 | 35 | 17.4 | 143 |
| Comp. Ex. 6 | −+ | 19 | 9.5 | 44 | 21.2 | 130 |

TABLE 12
test results of performances of anion exchange
membranes in electrolyzed water application

| | | polarization | internal |
|---|---|---|---|
| | hydrogen in oxygen | performance | resistance |
| group | (vol/%)@0.2 A/cm2 | (V@1 A/cm2) | (Ωcm2) |
| Ex. 17 | 2.02 | 1.79 | 0.185 |
| Comp. Ex. 3 | 2.66 | 2.09 | 0.225 |
| Comp. Ex. 4 | 2.33 | 2.06 | 0.201 |
| Comp. Ex. 5 | 2.29 | 2.02 | 0.196 |
| Comp. Ex. 6 | 2.92 | 2.13 | 0.241 |

### Examples 18-21, Comparative Examples 7-8

With reference to Example 1, Examples 18-21 and Comparative Examples 7-8 were designed, taking the acid catalysts used in the process of preparing anion exchange membranes as a variable, so as to show the influence of the selection of acid catalysts on the performances of anion exchange resins and anion exchange membranes.

Variables among Examples 18-21 and Comparative Examples 7-8 were the type and amount of acid catalyst in the process of preparing anion exchange membranes. The acid catalysts adopted in the above-mentioned examples and comparative examples in the process of preparing anion exchange membranes are shown in Table 13. Particularly, each of the acid catalysts used in Examples 1, 18-19 and Comparative Examples 7-8 was compounded by trifluoroacetic acid and trifluoromethanesulfonic acid with a volume ratio of trifluoroacetic acid to trifluoromethanesulfonic acid being 22.8:240. While the acid catalyst used in Example 20 is trifluoroacetic acid, and the acid catalyst used in Example 21 is trifluoromethanesulfonic acid. A usage equivalent of the acid catalyst, as listed in Table 13, took a feeding amount of monomer III as an equivalent reference.

Except for the variables shown in Table 13, other experimental operations and raw materials in Examples 18-21 and Comparative Examples 7-8 were strictly the same as those in Example 1.

TABLE 13
usage of acid catalysts in Examples
18-21 and Comparative Examples 7-8

| | | usage equivalent of acid | |
|---|---|---|---|
| group | composition of acid catalyst | catalyst | |
| Ex. 1 | trifluoroacetic acid + | 8.3 | eq |
| | trifluoromethanesulfonic acid | | |
| Ex. 18 | trifluoroacetic acid + | 4 | eq |
| | trifluoromethanesulfonic acid | | |
| Ex. 19 | trifluoroacetic acid + | 10 | eq |
| | trifluoromethanesulfonic acid | | |
| Comp. | trifluoroacetic acid + | 2 | eq |
| Ex. 7 | trifluoromethanesulfonic acid | | |
| Comp. | trifluoroacetic acid + | 15 | eq |
| Ex. 8 | trifluoromethanesulfonic acid | | |
| Ex. 20 | trifluoroacetic acid | 8.3 | eq |
| Ex. 21 | trifluoromethanesulfonic acid | 8.3 | eq |

The weight-average molecular weight and polydispersity index (PDI) of the nitrogen-containing branched polymers produced in the operation S4 in the process of preparing anion exchange resins in Examples 18-21 and Comparative Examples 7-8, are shown in Table 14. For the convenience of comparison, the weight-average molecular weight and polydispersity index (PDI) of the nitrogen-containing branched polymer obtained in Example 1 are also listed in Table 14. During the preparation of the nitrogen-containing branched polymer in Comparative Example 7, the polymerization reaction failed, resulting in an overly low molecular weight of the nitrogen-containing branched polymer. In Comparative Example 8, during the preparation of the nitrogen-containing branched polymer, an explosive polymerization occurred during a polymerization process, resulting in a non-uniform molecular weight of the nitrogen-containing branched polymer. Judging from the preparation of nitrogen-containing branched polymers in Examples 1, 18-21, it can be seen that using either trifluoroacetic acid or trifluoromethanesulfonic acid or a combination of trifluoroacetic acid and trifluoromethanesulfonic acid as an acid catalyst for preparing nitrogen-containing branched polymers can successfully catalyze the polymerization reaction of monomers and successfully produce nitrogen-containing branched polymers.

TABLE 14
weight-average molecular weight and PDI of nitrogen-
containing branched polymers produced in Examples
18-21 and Comparative Examples 7-8

| | weight-average | |
|---|---|---|
| group | molecular weight (g/mol) | PDI |
| Ex. 1 | 101431 | 1.97 |
| Ex. 18 | 34761 | 1.66 |
| Ex. 19 | 98952 | 1.75 |
| Comp. Ex. 7 | / | / |
| Comp. Ex. 8 | / | / |
| Ex. 20 | 41200 | 1.43 |
| Ex. 21 | 98431 | 1.73 |

Note:
“/” represents that the polymerization reaction during the preparation of a nitrogen-containing branched polymer failed resulting in no membrane property data, an explosive polymerization occurred resulting in a non-uniform molecular weight, or the polymer failed to be dissolved thus no membrane property data can be derived.

### Test Example 4

### 1. Test Objects

In this test example, anion exchange resins and anion exchange membranes produced in Examples 18-21 and Comparative Examples 7-8 were taken as test objects.

### 2. Test Items and Test Methods

The specific test items in this test example are as follows. The test method for each test item in this test example is consistent with the test method for the corresponding test item in Test Example 1.
(1) Solubility Test
(2) Mechanical Property Tests
a. Tensile Strength
b. Elongation at Break
(3) Water Absorption and Swelling Properties Test
(4) O⁻ Ionic Conductivity (conductivity test membrane state: OH⁻ @80° C.@ pure
water)
(5) Electrolyzed Water Test
a. EIS Test Process
b. Polarization Performance Test
c. Hydrogen in Oxygen Test

### 3. Test Results

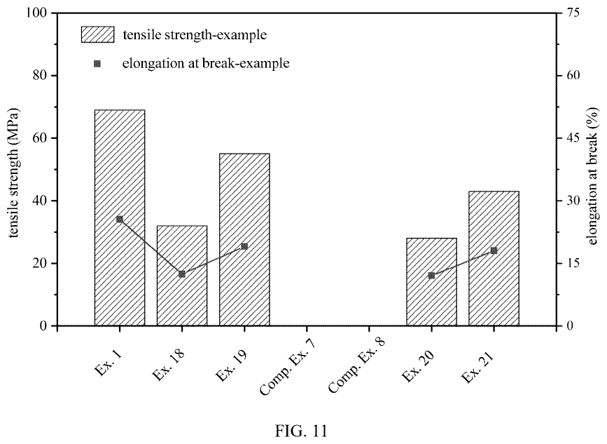

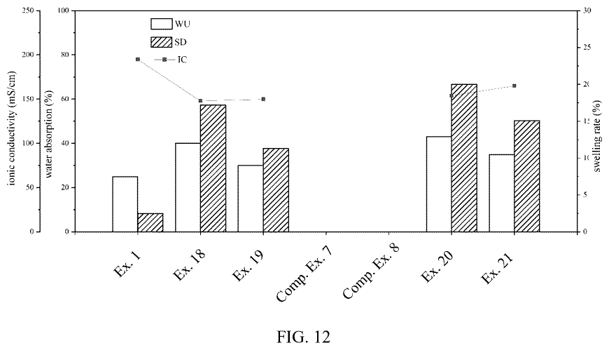

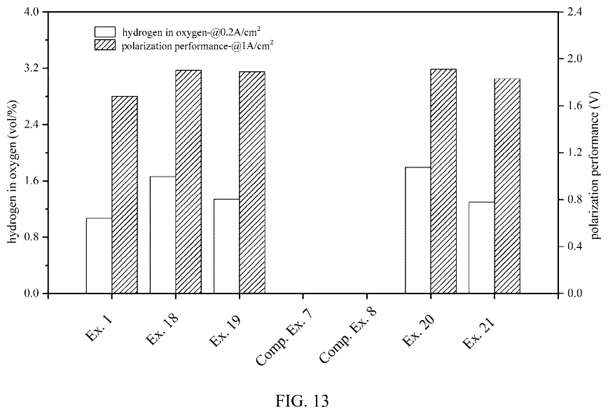

The test results of this test example are recorded in Table 15 and Table 16. Based on the data in Table 15, FIG. 11 was made. FIG. 11 shows a comparison of tensile strength and elongation at break of the test objects in this test example. Based on the data in Table 16, FIGS. 12-13 were made. FIG. 12 shows a comparison of ionic conductivity, water absorption rate, and swelling rate of the test objects in this test example, and FIG. 13 shows a comparison of content of hydrogen in oxygen and polarization performance of the alkaline membrane single cells applying the test objects in this test example.

The anion exchange resins produced in Comparative Examples 7-8 were both undissolved, and thus related performances of the test objects provided by Comparative Examples 7-8 could not be measured. Except for Comparative Examples 7-8, other test objects in this test example all had good comprehensive performances. Specifically, equivalents of the acid catalysts used in the polymerization reactions for preparing nitrogen-containing branched polymers in Examples 1 and 20-21 were the same. Under this condition, the comprehensive performance of the anion exchange resin and anion exchange membrane prepared in Example 1 were obvious better. Therefore, compared with using either trifluoroacetic acid or trifluoromethanesulfonic acid as the acid catalyst for preparing nitrogen-containing branched polymers respectively, combining trifluoroacetic acid and trifluoromethanesulfonic acid as the acid catalyst for preparing nitrogen-containing branched polymers can play a synergistic effect and further improve the comprehensive performances of the subsequently prepared anion exchange resin and anion exchange membrane.

TABLE 15
test results of performances of anion exchange resins and anion exchange membranes

| | | tensile strength | elongation at | water absorption | swelling | ionic conductivity |
|---|---|---|---|---|---|---|
| group | solubility | (MPa) | break (%) | rate (%) | rate (%) | (mS/cm) |
| Ex. 1 | ++ | 69 | 25.5 | 25 | 2.5 | 195 |
| Ex. 18 | ++ | 32 | 12.4 | 40 | 17.2 | 148 |
| Ex. 19 | ++ | 55 | 19 | 30 | 11.3 | 150 |
| Comp. Ex. 7 | / | / | / | / | / | / |
| Comp. Ex. 8 | / | / | / | / | / | / |
| Ex. 20 | ++ | 28 | 12 | 43 | 20 | 154 |
| Ex. 21 | ++ | 43 | 18 | 35 | 15.1 | 165 |

Note:
“/” represents that the polymerization reaction during the preparation of a nitrogen-containing branched polymer failed resulting in no membrane property data, an explosive polymerization occurred resulting in a non-uniform molecular weight, or the polymer failed to be dissolved thus no membrane property data can be derived.

TABLE 16
test results of performances of anion exchange
membranes in electrolyzed water application

| | | polarization | internal |
|---|---|---|---|
| | hydrogen in oxygen | performance | resistance |
| group | (vol/%)@0.2 A/cm2 | (V@1 A/cm2) | (Ωcm2) |
| Ex. 1 | 1.07 | 1.68 | 0.118 |
| Ex. 18 | 1.66 | 1.9 | 0.151 |
| Ex. 19 | 1.34 | 1.89 | 1.146 |
| Comp. Ex. 7 | / | / | / |
| Comp. Ex. 8 | / | / | / |
| Ex. 20 | 1.79 | 1.91 | 0.152 |
| Ex. 21 | 1.3 | 1.83 | 0.141 |

Note:
“/” represents that the polymerization reaction during the preparation of a nitrogen-containing branched polymer failed resulting in no membrane property data, an explosive polymerization occurred resulting in a non-uniform molecular weight, or the polymer failed to be dissolved thus no membrane property data can be derived.

### Examples 22-23

Anion exchange membranes of Examples 22-23 were prepared by referring to the method described in Example 1 for preparing the anion exchange membrane in Example 1. The types of monomer I, monomer II, and monomer III in the raw materials were different from that in Example 1. Based on the specific monomer I and monomer II selected, the reaction temperature and reaction duration of the oligomerization reaction in the operation S2 and the reaction temperature and reaction duration of the high-polymerization reaction in the operation S3 in the preparation of anion exchange membranes were adaptively adjusted. The specific data are shown in Table 17. Except for the above-mentioned differences, other experimental operations and raw material selections in Examples 22-23 are strictly the same as those in Example 1.

TABLE 17
variables in Examples 22-23

| | | | | oligomerization reaction | | high-polymerization reaction | |
|---|---|---|---|---|---|---|---|
| group | monomer I | monomer II | monomer III | temperature | duration | temperature | duration |
| Ex. 22 | quaterphenyl | 9,9′-bicarbazole | 3-quinuclidinone | 0° C. | 0.5 h | 10° C. | 4 h |
| Ex. 23 | biphenyl | 9,9′-bicarbazole | 3-quinuclidinone | 0° C. | 1.5 h | 10° C. | 8 h |

In the process of preparing the anion exchange membrane, the anion exchange resin produced in Example 22 is marked as anion exchange resin K, and the anion exchange resin produced in Example 23 is marked as anion exchange resin L.

The anion exchange resin K is

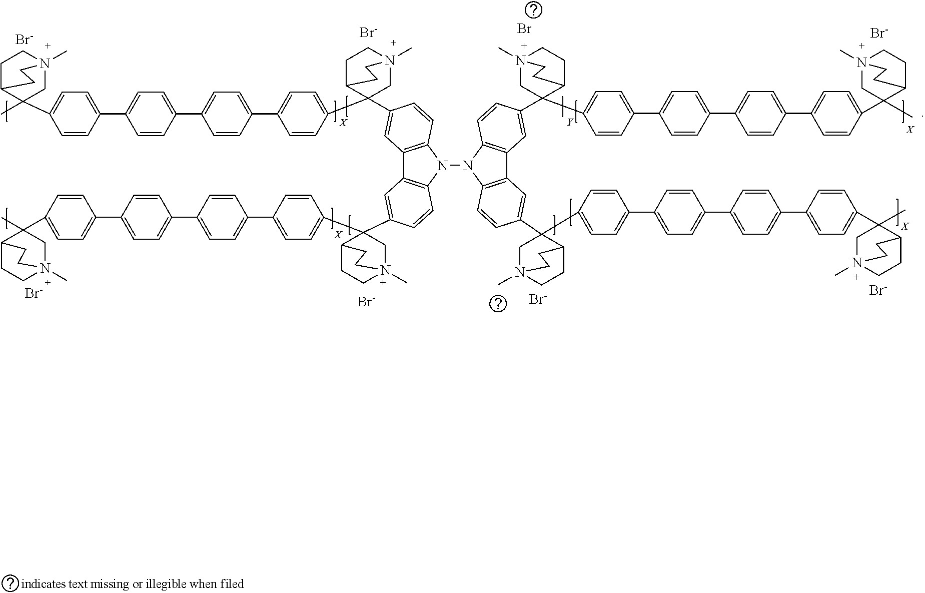

The anion exchange resin L is

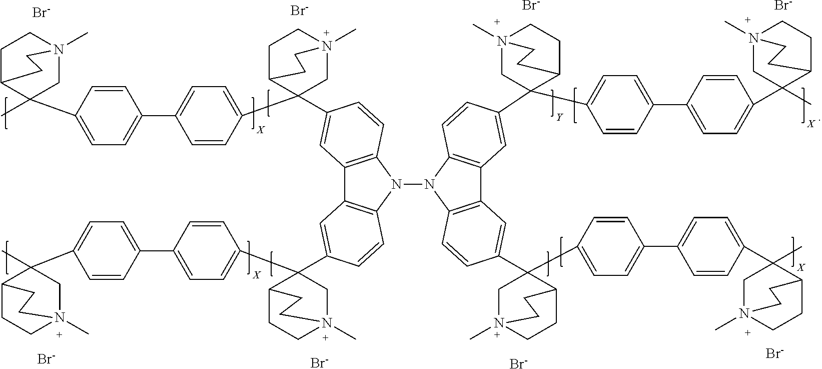

The above-mentioned embodiments are only used to illustrate the technical solutions of the present disclosure rather than limit the protection scope of the present disclosure. Although the present disclosure has been described in detail with reference to the preferred embodiments, those of ordinary skill in the art should understand that the technical solutions of the present disclosure can be modified or equivalently replaced without departing from the essence and scope of the technical solutions of the present disclosure.

What is claimed is:

1. A nitrogen-containing branched polymer, wherein a molecular structure of the nitrogen-containing branched polymer comprises a nitrogen-containing heterocycle, a branched structure, and an aryl group, the number of branching site of the branched structure is not less than 3, and the aryl group is connected to the branching site of the branched structure through the nitrogen-containing heterocycle;
the aryl group and the branched structure satisfy a relationship: A:B=80-99:1-20, wherein A represents a molar proportion of the aryl group in the nitrogen-containing branched polymer, and B represents a molar proportion of the branched structure in the nitrogen-containing branched polymer;
a polydispersity index of the nitrogen-containing branched polymer is not greater than 2.6, and a weight-average molecular weight of the nitrogen-containing branched polymer is in a range of 40,000 g/mol-500,000 g/mol.

2. The nitrogen-containing branched polymer as claimed in claim 1, wherein the aryl group comprises at least one selected from the group consisting of biphenyl, terphenyl, and quaterphenyl.

3. The nitrogen-containing branched polymer as claimed in claim 1, wherein the branched structure comprises a benzene ring with the branching site.

4. The nitrogen-containing branched polymer as claimed in claim 3, wherein the branched structure comprises at least one structural unit selected from the group consisting of 1,3,5-triphenylbenzene, triphenylmethane, 9,10-benzophenanthrene, tetraphenylmethane, triptycene, 9,9-diphenylfluorene, 9,9′-spirobi[9H-fluorene], 9,9′-bifluorene, 9,9′-bicarbazole, 4,4′-bis(9-carbazolyl)-1,1′-biphenyl, 2-(9,9″-spirobifluoren-2-yl)-9,9″-spirobifluorene, and triphenylamine.

5. The nitrogen-containing branched polymer as claimed in claim 1, wherein the nitrogen-containing heterocycle comprises at least one of piperidine ring and quinuclidine ring.

6. The nitrogen-containing branched polymer as claimed in claim 1, wherein a molecular structure of the nitrogen-containing branched polymer comprises a chain segment I and a chain segment II;
a structural formula of the chain segment I is [symbol] A-Ar₁ [symbol] ₓ, wherein A represents the nitrogen-containing heterocycle, Ar1 represents the aryl group, and x represents a degree of polymerization of the chain segment I;
the chain segment II is composed of the nitrogen-containing heterocycle and the branched structure, and in the chain segment II, the nitrogen-containing heterocycle is directly connected to the branching site of the branched structure.

7. The nitrogen-containing branched polymer as claimed in claim 6, wherein the nitrogen-containing branched polymer comprises a basic structural unit formed by connecting the chain segment I with the chain segment II;
in the basic structural unit, the aryl group in the chain segment I is connected to the nitrogen-containing heterocycle in the chain segment II.

8. The nitrogen-containing branched polymer as claimed in claim 7, wherein in the basic structural unit, the number of the chain segment I directly connected to each chain segment II is ≥3.

9. The nitrogen-containing branched polymer as claimed in claim 1, wherein the weight-average molecular weight of the nitrogen-containing branched polymer is 40000 g/mol-250000 g/mol.

10. The nitrogen-containing branched polymer as claimed in claim 1, wherein the aryl group is terphenyl.

11. The nitrogen-containing branched polymer as claimed in claim 10, wherein the nitrogen-containing polymer comprises at least one selected from the group consisting of a nitrogen-containing branched polymer A, a nitrogen-containing branched polymer B, a nitrogen-containing branched polymer C, a nitrogen-containing branched polymer D, and a nitrogen-containing branched polymer E;
the nitrogen-containing branched polymer A is 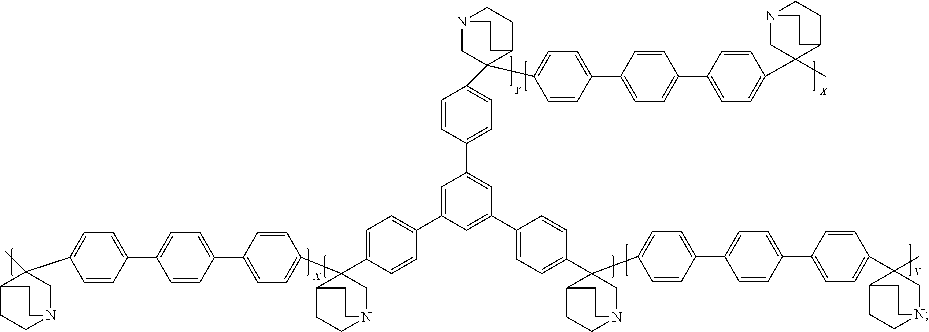
the nitrogen-containing branched polymer B is 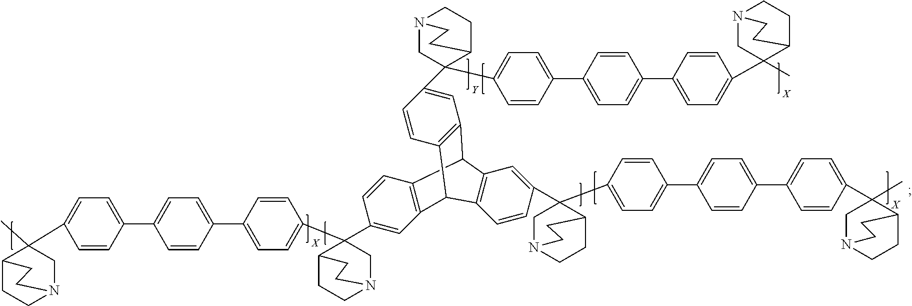
the nitrogen-containing branched polymer C is 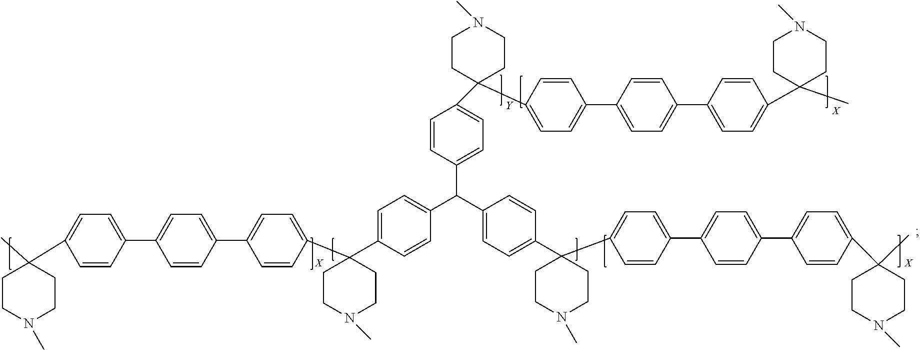
the nitrogen-containing branched polymer D is 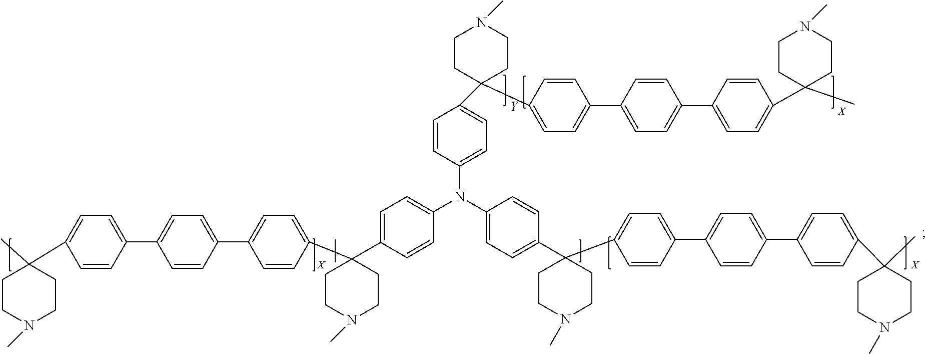
and
the nitrogen-containing branched polymer E is

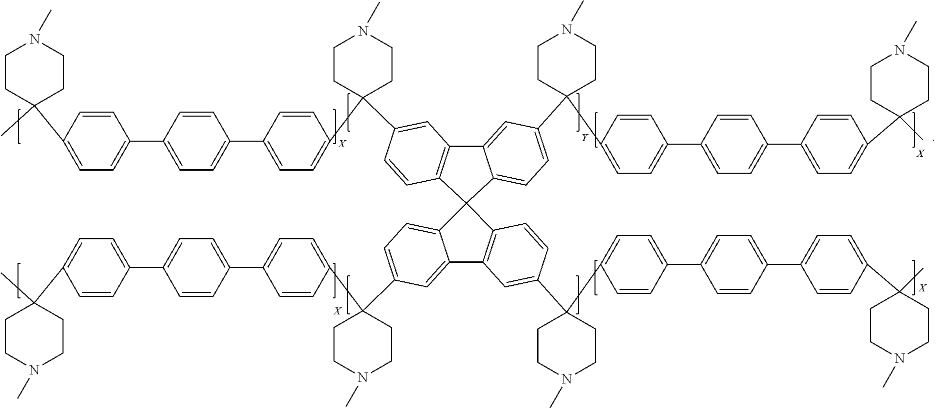

12. A method for preparing an anion exchange resin, wherein the anion exchange resin comprises a nitrogen-containing branched polymer; a molecular structure of the nitrogen-containing branched polymer comprises a nitrogen-containing heterocycle, a branched structure, and an aryl group, the number of branching site of the branched structure is not less than 3, and the aryl group is connected to the branching site of the branched structure through the nitrogen-containing heterocycle; the aryl group and the branched structure satisfy a relationship: A:B=80-99:1-20, wherein A represents a molar proportion of the aryl group in the nitrogen-containing branched polymer, and B represents a molar proportion of the branched structure in the nitrogen-containing branched polymer; a polydispersity index of the nitrogen-containing branched polymer is not greater than 2.6, and a weight-average molecular weight of the nitrogen-containing branched polymer is in a range of 40,000 g/mol-500,000 g/mol;
the method for preparing an anion exchange resin comprises:
S1. preparing a reaction monomer mixture containing a monomer I, a monomer II, and a monomer III, and adding an acid catalyst to the reaction monomer mixture under a temperature of −5° C.-0° C. to obtain a reaction solution; wherein the monomer I is an aryl monomer, the monomer II is a monomer containing the branched structure, and the monomer III is a monomer containing the nitrogen-containing heterocycle;
S2. subjecting the reaction solution to an oligomerization reaction to produce an oligomer mixture, wherein a reaction temperature of the oligomerization reaction is 0° C.-10° C.;
S3. subjecting the oligomer mixture to a high-polymerization reaction, wherein a reaction temperature of the high-polymerization reaction is 0° C.-24° C.;
S4. separating a polymer from a product of the high-polymerization reaction, and performing an acid-removal treatment on the polymer to obtain the nitrogen-containing branched polymer; and
S5. preparing a quaternization reaction solution by adding the nitrogen-containing branched polymer and a quaternization reagent to a solvent B for a quaternization reaction, and separating the anion exchange resin from a product of the quaternization reaction.

13. The method for preparing the anion exchange resin as claimed in claim 12, wherein the monomer I comprises at least one selected from the group consisting of

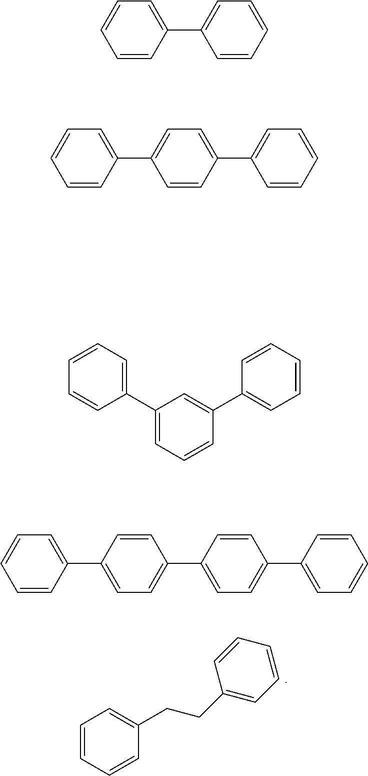

14. The method for preparing the anion exchange resin as claimed in claim 12, wherein the monomer II comprises at least one selected from the group consisting of:

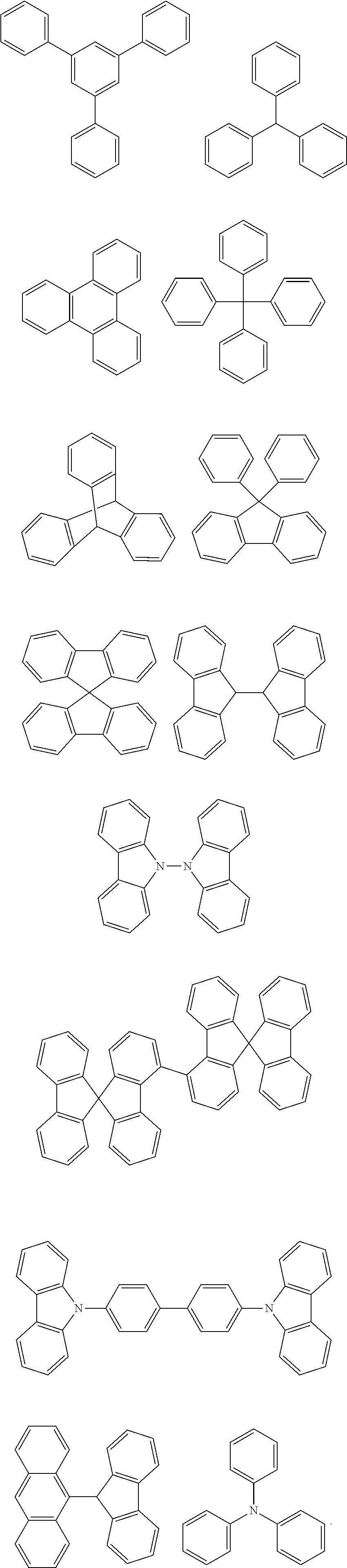

15. The method for preparing the anion exchange resin as claimed in claim 12, wherein the monomer III comprises at least one of a piperidone monomer and a quinuclidone monomer.

16. The method for preparing the anion exchange resin as claimed in claim 15, wherein the piperidone monomer comprises at least one selected from the group consisting of: 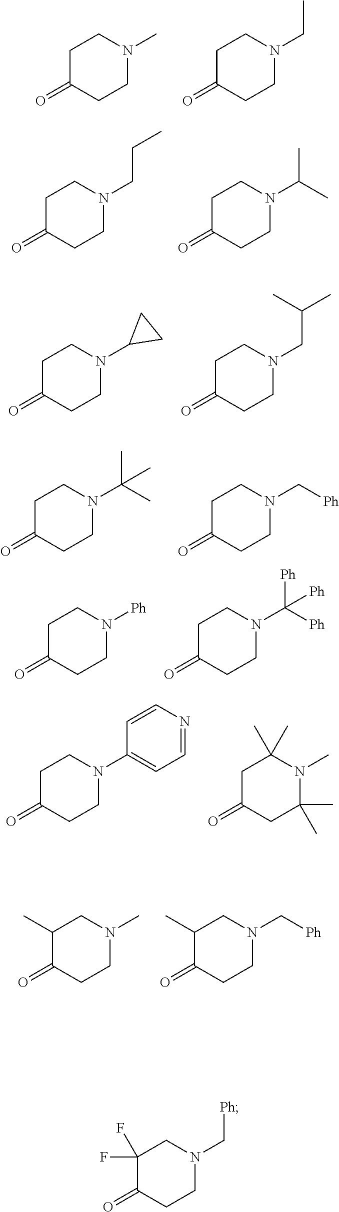
the quinuclidone monomer comprises at least one selected from the group consisting of:

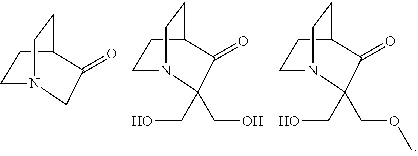

17. The method for preparing the anion exchange resin as claimed in claim 12, wherein the acid catalyst comprises at least one selected from the group consisting of methanesulfonic acid, pentafluoropropionic acid, trifluoroacetic acid, trifluoromethanesulfonic acid, and heptafluorobutyric acid;
taking a feeding amount of the monomer III as an equivalent reference, a feeding amount of the acid catalyst is 4-14 eq.

18. The method for preparing the anion exchange resin as claimed in claim 12, wherein the quaternization reagent comprises at least one selected from the group consisting of methyl trifluoroacetate, methyl p-toluenesulfonate, methyl iodide, propyl bromide, ethyl iodide, propyl iodide, butyl iodide, pentyl iodide, hexyl iodide, ethyl bromide, butyl bromide, pentyl bromide, hexyl bromide, bromocyclohexane, bromocyclopentane, bromocyclohexane, methyl methanesulfonate, ethyl methanesulfonate, propyl methanesulfonate, butyl methanesulfonate, propyl ethanesulfonate, ethyl ethanesulfonate, 3-butynyl methanesulfonate, Ethenesulfonic acid, 2-propenyl ester, methyl benzenesulfonate, methyl nitrobenzenesulfonate, methyl trifluoromethanesulfonate, ethyl trifluoromethanesulfonate, ethyl toluenesulfonate, toluene-4-sulfonic acid cyclobutyl ester, butyl toluene-4-sulphonate, benzenesulfonic acid neopentyl ester, tetrahydro-2H-pyran-4-yl methanesulfonate, and cyclohexyl p-toluenesulfonate.

19. The method for preparing the anion exchange resin as claimed in claim 12, wherein the preparing the reaction monomer mixture comprises:
adding the monomer I, the monomer II, and the monomer III to a solvent A, wherein the solvent A is composed of at least one selected from the group consisting of dichloromethane, trichloromethane, chloroform, and tetrahydrofuran.

20. An anion exchange membrane, comprising a nitrogen-containing branched polymer, wherein a molecular structure of the nitrogen-containing branched polymer comprises a nitrogen-containing heterocycle, a branched structure, and an aryl group, the number of branching site of the branched structure is not less than 3, and the aryl group is connected to the branching site of the branched structure through the nitrogen-containing heterocycle; the aryl group and the branched structure satisfy a relationship: A:B-80-99:1-20, wherein A represents a molar proportion of the aryl group in the nitrogen-containing branched polymer, and B represents a molar proportion of the branched structure in the nitrogen-containing branched polymer; a polydispersity index of the nitrogen-containing branched polymer is not greater than 2.6, and a weight-average molecular weight of the nitrogen-containing branched polymer is in a range of 40,000 g/mol-500,000 g/mol.
